(19) United States
(12) Patent Application Publication
(10) Pub. No.: US 2026/0227179 A1
(43) Pub. Date: Aug. 6, 2026

(54) MEASUREMENT PATH GENERATING DEVICE, MEASUREMENT PATH GENERATING METHOD, AND MEASUREMENT SYSTEM

(71) Applicant: Mitsubishi Electric Corporation, Tokyo (JP)

(72) Inventors: Hiroki KANEKO, Tokyo (JP); Ryosuke IKEDA, Tokyo (JP)

(73) Assignee: Mitsubishi Electric Corporation, Tokyo (JP)

(21) Appl. No.: 19/148,374

(22) PCT Filed: Apr. 14, 2023
(86) PCT No.: PCT/JP2023/015197

§ 371 Date: Jul. 16, 2025

(51) Int. Cl. G01B 11/24; G01B 9/02004; G01B 11/02; G01B 11/30

(52) U.S. Cl. CPC G01B 11/24; G01B 9/02004; G01B 11/026; G01B 11/30

(57) ABSTRACT

A measurement path generating device includes: a shape model storage unit that stores a shape model of a measurement object; a measurement target curve generating unit that generates a measurement target curve of the shape model; a reference point calculating unit that calculates a reference point on the measurement target curve and a normal direction of the measurement object curved surface at the reference point; and a measurement path generating unit that generates a measurement path based on the reference point, the normal direction, a measurement-performable distance range between a measurement sensor and the measurement target curve, and a measurement-performable angle range between a measurement direction of the measurement sensor and the normal direction of the measurement object curved surface. The measurement path generating device generates the measurement path that enables on-machine measurement with high accuracy while reducing time and effort required for measuring the measurement object.

### FIELD

The present disclosure relates to a measurement path generating device, a measurement path generating method, and a measurement system for measuring a measurement object on a machine tool using a measurement sensor.

### BACKGROUND

Conventionally, on-machine measurement has been performed in which a measurement sensor such as an optical distance sensor is used to measure dimensions of a workpiece or a shape of the workpiece on a machine tool. In the on-machine measurement, the measurement sensor is relatively moved following the shape of the workpiece, and a measured value obtained from the measurement sensor and a position of the measurement sensor on the machine tool when the measured value is obtained are synchronously acquired. At this time, it is necessary to control a movement path of the measurement sensor for the measurement sensor to measure the workpiece and an attitude of the measurement sensor on the movement path.

Patent Literature 1 discloses a shape measurement method for measuring a distance by moving a measurement sensor roughly along a surface of an assumed shape of a measurement object while maintaining a distance, in a measurement direction, between the surface of the assumed shape and the measurement sensor within a predetermined range. Patent Literature 1 also discloses that the attitude of the measurement sensor is controlled so as to be perpendicular to the surface of the assumed shape. The shape measurement method described in Patent Literature 1 aims to perform measurement by moving the measurement sensor within a distance range where measurement can be performed even for a highly rugged object.

In addition, Patent Literature 2 discloses a method for determining a relative direction between a measurement object and a measurement device along a movement path in order to avoid a collision between the measurement object and the measurement device during movement.

### CITATION LIST

### Patent Literature

Patent Literature 1: Japanese Patent Application Laid-open No. H3-21814
Patent Literature 2: Japanese Translation of PCT International Application Laid-open No. 2010-537184

### SUMMARY OF INVENTION

### Problem to be Solved by the Invention

The optical distance sensor as one type of the measurement sensors emits output light toward the measurement object and receives reflected light reflected by the measurement object. Then, the optical distance sensor uses a portion of the output light before being emitted to the measurement object as reference light, and measures the distance to the measurement object on the basis of interference light between the reference light and the reflected light. Here, in order for the optical distance sensor to receive the reflected light, a measurement direction as a direction in which the output light is emitted from the optical distance sensor and a normal direction of a surface at a measurement position of the measurement object need only be within a predetermined angle.

However, in the techniques described in Patent Literature 1 and Patent Literature 2, a measurement path is not generated in consideration of setting the measurement direction of the measurement sensor and the normal direction of the surface of the measurement object within the predetermined angle. In such a case, the technique described in Patent Literature 1 has a problem that, by performing unnecessary attitude control that makes the measurement direction of the measurement sensor perpendicular to the surface of the measurement object, the time required for measurement increases.

Moreover, in the technique described in Patent Literature 2, even if the relative direction between the measurement object and the measurement sensor is determined to avoid a collision between the measurement object and the measurement sensor, there is no guarantee that the measurement direction of the measurement sensor and the normal direction of the surface of the measurement object are within the predetermined angle, and the measurement path may be one with which appropriate measurement cannot be performed, resulting in a problem that it takes effort to correct the measurement path.

The present disclosure has been made in view of the above, and an object of the present disclosure is to provide a measurement path generating device capable of generating a measurement path that enables on-machine measurement of a measurement object with high accuracy while reducing time required for measuring the measurement object in the on-machine measurement and effort of an operator required for measuring the measurement object.

### Means to Solve the Problem

In order to solve the above-described problems and achieve the object, a measurement path generating device according to the present disclosure generates a measurement path for measuring a measurement object by a measurement sensor on a machine tool, the measurement path being a movement path that is relative between the measurement sensor and the measurement object. The measurement path generating device includes: a shape model storage unit that stores a shape model of the measurement object; a measurement target curve generating unit to generate a measurement target curve that is a curve on a measurement object curved surface of the shape model; a reference point calculating unit to calculate a reference point that is a point on the measurement target curve and a normal direction of the measurement object curved surface at the reference point; and a measurement path generating unit to generate the measurement path, which is the movement path for performing measurement on the measurement target curve, on the basis of the reference point, the normal direction, a measurement-performable distance range that is a distance range in which measurement can be performed between the measurement sensor and the measurement target curve, and a measurement-performable angle range that is a relative angle range in which measurement can be performed between a measurement direction of the measurement sensor and the normal direction of the measurement object curved surface.

### Effects of the Invention

The measurement path generating device according to the present disclosure achieves an effect of generating the measurement path that enables the on-machine measurement of the measurement object with high accuracy while reducing the time required for measuring the measurement object in the on-machine measurement and the effort of the operator required for measuring the measurement object.

### BRIEF DESCRIPTION OF DRAWINGS

FIG. 1 is a diagram illustrating an exemplary configuration of a measurement system according to a first embodiment.

FIG. 2 is a diagram illustrating a configuration of a measurement path generating device according to the first embodiment.

FIG. 3 is a diagram illustrating a configuration of a path processing unit included in the measurement path generating device according to the first embodiment.

FIG. 4 is a flowchart illustrating an example of a procedure of operation of the measurement path generating device according to the first embodiment.

FIG. 5 is a perspective view illustrating an example of a shape model used in the measurement path generating device according to the first embodiment.

FIG. 6 is a side view of the example of the shape model used in the measurement path generating device according to the first embodiment.

FIG. 7 is a perspective view illustrating a state in which a measurement object curved surface of the shape model is designated for use in the measurement path generating device according to the first embodiment.

FIG. 8 is a diagram illustrating how planes are generated in the shape model used in the measurement path generating device according to the first embodiment,

FIG. 9 is a diagram illustrating the planes in FIG. 8.

FIG. 10 is a top view of FIG. 8.

FIG. 11 is a perspective view illustrating a state in which measurement target curves are generated on the measurement object curved surface of the shape model used in the measurement path generating device according to the first embodiment.

FIG. 12 is a side view illustrating the state in which the measurement target curve is generated on the measurement object curved surface of the shape model used in the measurement path generating device according to the first embodiment.

FIG. 13 is a diagram illustrating how reference points and normal directions of the measurement object curved surface at the reference points are calculated on the measurement target curve of the shape model used in the measurement path generating device according to the first embodiment.

FIG. 14 is a diagram illustrating an example of measurement-performable areas determined on the basis of a measurement-performable distance range and a measurement-performable angle range in the shape model used in the measurement path generating device according to the first embodiment.

FIG. 15 is a first diagram illustrating how measurement positions and measurement directions of a measurement sensor are calculated for measuring the reference points used in the measurement path generating device according to the first embodiment.

FIG. 16 is a second diagram illustrating how measurement positions and measurement directions of the measurement sensor are calculated for measuring the reference points used in the measurement path generating device according to the first embodiment.

FIG. 17 is a third diagram illustrating how measurement positions and measurement directions of the measurement sensor are calculated for measuring the reference points used in the measurement path generating device according to the first embodiment.

FIG. 18 is a fourth diagram illustrating how measurement positions and measurement directions of the measurement sensor are calculated for measuring the reference points used in the measurement path generating device according to the first embodiment.

FIG. 19 is a fifth diagram illustrating how measurement positions and measurement directions of the measurement sensor are calculated for measuring the reference points used in the measurement path generating device according to the first embodiment.

FIG. 20 is a diagram illustrating how a measurement path is generated in the measurement path generating device according to the first embodiment.

FIG. 21 is a diagram illustrating how the measurement path is displayed on a display unit of the measurement path generating device according to the first embodiment.

FIG. 22 is a perspective view illustrating a state in which a measurement target curve is generated on a measurement object curved surface of a shape model used by a measurement path generating device in a second embodiment.

FIG. 23 is a diagram illustrating how reference points and normal directions of the measurement object curved surface at the reference points are calculated on the measurement target curve of the shape model used by the measurement path generating device in the second embodiment.

FIG. 24 is a diagram illustrating an example of measurement-performable areas determined on the basis of a measurement-performable distance range and a measurement-performable angle range in the shape model used by the measurement path generating device in the second embodiment.

FIG. 25 is a first diagram illustrating how the measurement path generating device calculates measurement positions and measurement directions of a measurement sensor in the second embodiment.

FIG. 26 is a second diagram illustrating how the measurement path generating device calculates the measurement positions and measurement directions of the measurement sensor in the second embodiment.

FIG. 27 is a diagram illustrating how the measurement path generating device generates a measurement path in the second embodiment.

FIG. 28 is a perspective view illustrating a state in which a measurement target curve is generated on a measurement object curved surface of a shape model used by a measurement path generating device in a third embodiment.

FIG. 29 is a diagram illustrating how reference points and normal directions of the measurement object curved surface at the reference points are calculated on the measurement target curve of the shape model used by the measurement path generating device in the third embodiment.

FIG. 30 is a diagram illustrating an example of measurement-performable areas determined on the basis of a measurement-performable distance range and a measurement-performable angle range in the shape model used by the measurement path generating device in the third embodiment.

FIG. 31 is a diagram illustrating a state in which a plane R1, which is a plane along which measurement positions can be moved in all measurement-performable areas, is determined in the shape model used by the measurement path generating device in the third embodiment.

FIG. 32 is a diagram illustrating how the measurement path generating device calculates measurement positions and measurement directions of a measurement sensor in the third embodiment.

FIG. 33 is a diagram illustrating how the measurement path generating device generates a measurement path in the third embodiment.

FIG. 34 is a diagram illustrating a configuration in which the functions of each of control units according to the first to third embodiments are implemented by hardware.

FIG. 35 is a diagram illustrating a configuration in which the functions of each of the control units according to the first to third embodiments are implemented by software.

### DESCRIPTION OF EMBODIMENTS

Hereinafter, a measurement path generating device, a measurement path generating method, and a measurement system according to embodiments will be described in detail with reference to the drawings.

### First Embodiment

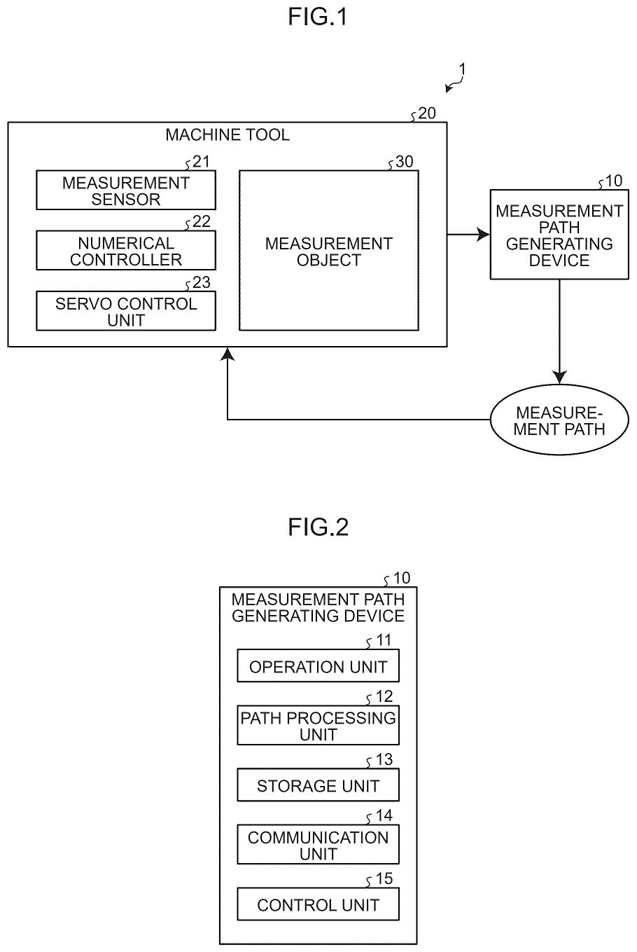

FIG. 1 is a diagram illustrating an exemplary configuration of a measurement system according to a first embodiment. A measurement system 1 is a system that performs on-machine measurement to measure a measurement object 30 on a machine tool 20, that is, on-machine measurement to measure a dimension of the measurement object 30 or a shape of the measurement object 30 on the machine tool 20. The measurement system 1 according to the first embodiment includes a measurement path generating device 10 and the machine tool 20.

The machine tool 20 includes a measurement sensor 21, a numerical controller 22, and a servo control unit 23. Also, in the machine tool 20, the measurement object 30 such as an object to be machined is disposed.

The measurement sensor 21 is installed on at least one of drive axes of the machine tool 20 and measures a distance to a specified object, that is, in the example of FIG. 1, a distance between the measurement object 30 and the measurement sensor 21.

The numerical controller 22 controls the operation of the machine tool 20 to control machining of the object to be machined by the machine tool 20. On the basis of a set program, the numerical controller 22 outputs a control signal for controlling the operation of the machine tool 20 including a position command, a speed command, and the like to the servo control unit 23. Similarly, in the case of the on-machine measurement using the measurement sensor 21 attached to the drive axis of the machine tool 20, the numerical controller 22 outputs, on the basis of the set program, the control signal for controlling the operation of the machine tool 20 including the position command, the speed command, and the like to the servo control unit 23.

In response to the output from the numerical controller 22, that is, in response to the control signal output from the numerical controller 22, the servo control unit 23 outputs a servo signal, which includes information such as information of a current for operating the drive axis of the machine tool 20 and an actual position of the drive axis, to the drive axis of the machine tool 20. Similarly, in the case of the on-machine measurement using the measurement sensor 21 attached to the drive axis of the machine tool 20, the servo control unit 23 outputs, in response to the output from the numerical controller 22, that is, in response to the control signal output from the numerical controller 22, the servo signal to the drive axis of the machine tool 20, the servo signal including the information such as the information of the current for operating the drive axis of the machine tool 20 to which the measurement sensor 21 is attached and the actual position of the drive axis.

The measurement path generating device 10 generates a measurement path that is a relative movement path between the measurement sensor 21 and the measurement object 30 for measuring the measurement object 30 by the measurement sensor 21 on the machine tool 20. The measurement path generating device 10 includes a computer in which a measurement path generating program for generating the measurement path is installed.

Here, a change in a relative position between the measurement sensor and the measurement object is represented as a path and referred to as the relative movement path. For example, a position of the measurement sensor 21 with respect to the measurement object 30, that is, a relative position of the measurement sensor 21 with respect to a position of the measurement object 30 is expressed as a coordinate position. Then, a series of changes in the coordinate position when the measurement sensor 21 and the measurement object 30 move may be represented as a path and serve as the relative movement path.

FIG. 2 is a diagram illustrating a configuration of the measurement path generating device according to the first embodiment. The measurement path generating device 10 according to the first embodiment includes an operation unit 11, a path processing unit 12, a storage unit 13, a communication unit 14, and a control unit 15. The components of the measurement path generating device 10 above can exchange information with one another.

The operation unit 11 is an operation receiving unit that receives a user operation, that is, a setting operation from a user. The operation unit 11 receives input of the user operation and transmits information corresponding to the user operation to the component in the measurement path generating device 10. The operation unit 11 includes an input device such as a keyboard and/or a mouse. Note that the measurement path generating device 10 may be configured not to include the operation unit 11.

The path processing unit 12 performs processing of generating the measurement path, which is the movement path along which the measurement sensor 21 performs measurement, in the case where the on-machine measurement is performed to measure the dimension of the measurement object 30 or the shape of the measurement object 30 on the machine tool 20 using the measurement sensor 21. Information on the measurement path generated by the path processing unit 12 is transmitted to the numerical controller 22.

The storage unit 13 stores various types of information used to control the measurement path generating device 10.

The communication unit 14 communicates with a device outside the measurement path generating device 10.

The control unit 15 controls the overall operation of the measurement path generating device 10.

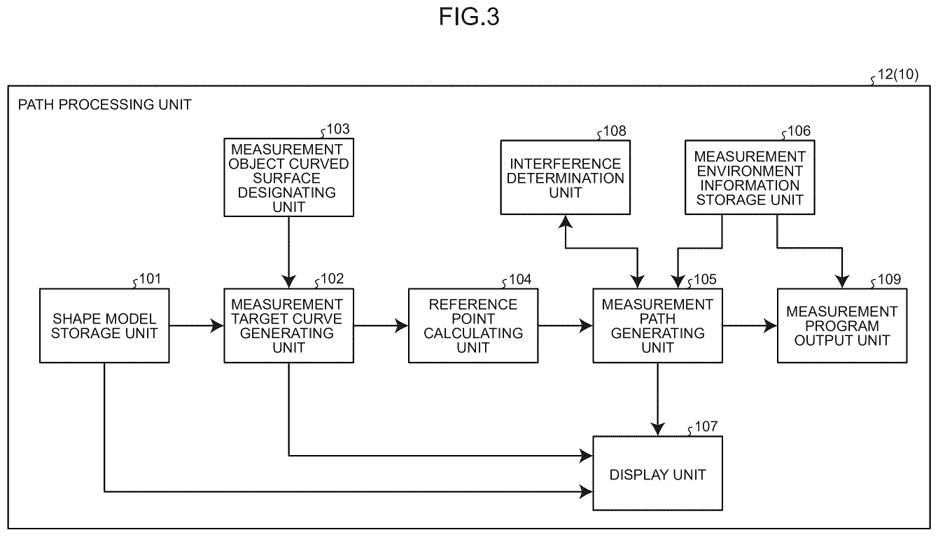

FIG. 3 is a diagram illustrating a configuration of the path processing unit included in the measurement path generating device according to the first embodiment. The measurement path generating device 10 includes a shape model storage unit 101, a measurement target curve generating unit 102, a measurement object curved surface designating unit 103, a reference point calculating unit 104, a measurement path generating unit 105, a measurement environment information storage unit 106, a display unit 107, an interference determination unit 108, and a measurement program output unit 109. The components of the path processing unit 12 above can exchange information with one another.

The shape model storage unit 101 stores a shape model that represents the shape of the measurement object 30 and is input from outside the measurement path generating device 10. The measurement object 30 includes, for example, a workpiece before machining, a workpiece after machining, an attaching tool for a workpiece, a cutting tool, a structure of the machine tool 20, or the like. A method of inputting the shape model into the shape model storage unit 101 includes a method of converting data from computer aided design (CAD) data, a method of inputting a figure by an operator's operation using an input device such as a keyboard, and the like.

The measurement target curve generating unit 102 generates a measurement target curve that is a curve on a measurement object curved surface of the shape model of the measurement object 30. The measurement object curved surface is a curved surface on the shape model of the measurement object 30 that is subjected to the on-machine measurement by the measurement sensor 21.

The measurement object curved surface designating unit 103 designates the measurement object curved surface that is a curved surface on which measurement is performed among a plurality of curved surfaces of the shape model of the measurement object 30.

The reference point calculating unit 104 calculates reference points that are points on the measurement target curve, and normal directions of the measurement object curved surface at the reference points.

The measurement path generating unit 105 generates the measurement path, which is the movement path for performing measurement on the measurement target curve, on the basis of the reference points, the normal directions at the reference points, a measurement-performable distance range that is a distance range where measurement can be performed between the measurement sensor 21 and the measurement target curve, and a measurement-performable angle range that is a relative angle range where measurement can be performed between a measurement direction of the measurement sensor 21 and the normal direction of the measurement object curved surface.

The measurement environment information storage unit 106 stores measurement environment information that is information including various conditions regarding a measurement environment when the measurement sensor 21 measures the measurement object 30. The measurement environment information includes at least one of: a type of the measurement sensor; a measurement method of the measurement sensor; a wavelength of output light of the measurement sensor; a focal length of the measurement sensor; a measurement cycle of the measurement sensor; material of the measurement object; and surface roughness of the measurement object.

The display unit 107 includes a display screen and a display control unit that controls display of information on the display screen, and displays various types of information inside the measurement path generating device 10.

The interference determination unit 108 determines the presence of absence of interference between the measurement sensor 21 and the shape model of the measurement object 30 on the basis of information of the shape model, information of the measurement object curved surface, information of the measurement target curve, information of the coordinate positions of the reference points on the measurement target curve, information of the normal directions of the measurement object curved surface at the reference points, information of specifications of the measurement sensor 21, information of the shape of the measurement sensor 21, and information of the measurement position and the measurement direction of the measurement sensor 21 for measuring each reference point.

The measurement program output unit 109 generates a measurement program describing a command for relatively moving the measurement sensor 21 and the measurement object 30 along the measurement path, which is generated by the measurement path generating unit 105, on the basis of the configuration of the drive axes of the machine tool 20.

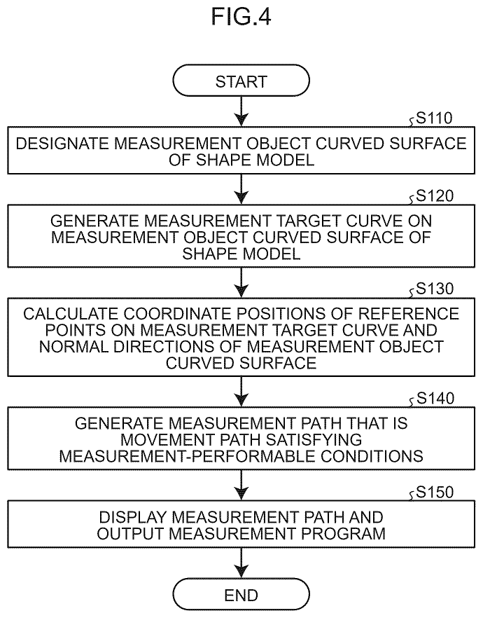

Next, the operation of the path processing unit 12 of the measurement path generating device 10 configured as described above will be described. FIG. 4 is a flowchart illustrating an example of a procedure of operation of the measurement path generating device according to the first embodiment.

First, in step S110, the measurement object curved surface of the shape model is designated. Specifically, first, the measurement target curve generating unit 102 acquires the shape model stored in the shape model storage unit 101. The shape model of the measurement object is stored in advance in the shape model storage unit 101 in a shape model storing step.

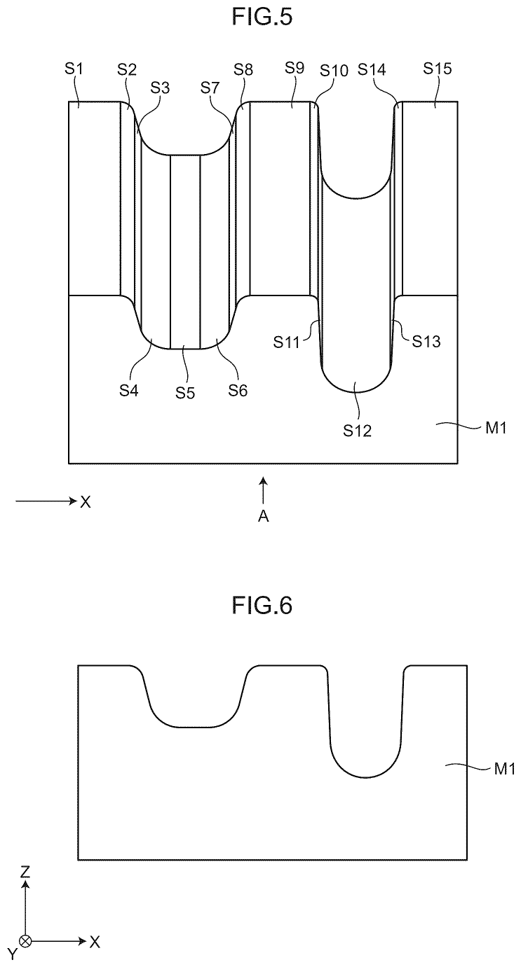

FIG. 5 is a perspective view illustrating an example of the shape model used in the measurement path generating device according to the first embodiment, FIG. 5 is the perspective view illustrating a shape model M1, which is the shape model representing the shape of the measurement object 30, and curved surfaces S1 to S15 included in the shape model M1. In the shape model M1, two concave shapes along a Y direction are formed by the curved surfaces. FIG. 6 is a side view of the example of the shape model used in the measurement path generating device according to the first embodiment. FIG. 6 illustrates a side surface of the shape model M1 illustrated in FIG. 5 as viewed from the direction of an arrow A in FIG. 5.

A horizontal direction in FIGS. 5 and 6 is defined as a width direction of the shape model M1. The width direction of the shape model M1 corresponds to an X direction in FIGS. 5 and 6. A vertical direction in FIGS. 5 and 6 is defined as a height direction of the shape model M1. The height direction of the shape model M1 corresponds to a Z direction in FIGS. 5 and 6. Moreover, a direction orthogonal to the width direction of the shape model M1 and the height direction of the shape model M1 is defined as the width direction of the shape model M1. The width direction of the shape model M1 corresponds to the Y direction in FIG. 6.

Next, the measurement object curved surface that is a curved surface subject to measurement is designated from among the plurality of the curved surfaces included in the shape model. The measurement object curved surface is designated by the measurement object curved surface designating unit 103 from among the plurality of the curved surfaces included in the shape model according to instruction information input from an operator. The measurement object curved surface designating unit 103 transmits designation information of the measurement object curved surface, which is information of the curved surface designated as the measurement object curved surface, to the measurement target curve generating unit 102.

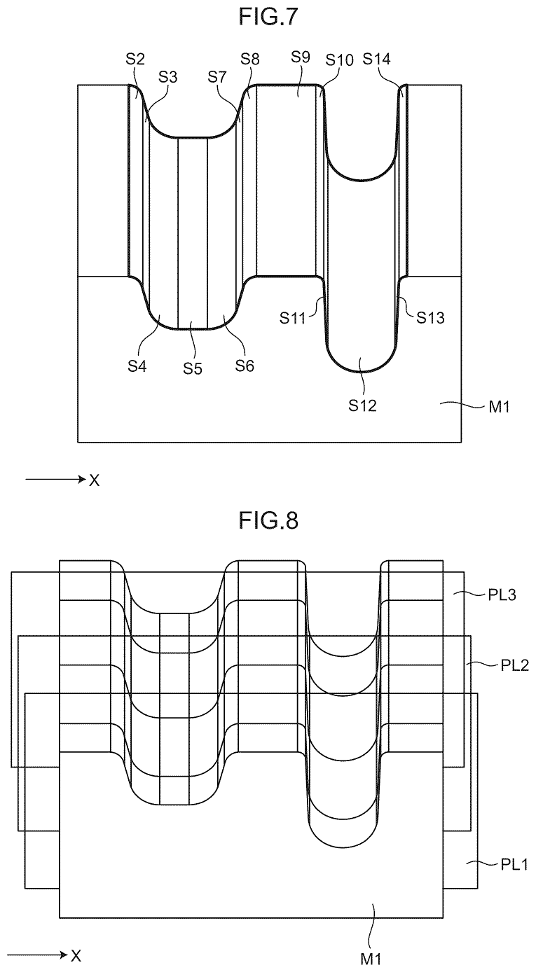

FIG. 7 is a perspective view illustrating a state in which the measurement object curved surface of the shape model is designated for use in the measurement path generating device according to the first embodiment. FIG. 7 illustrates a state in which the curved surfaces S2 to S14, which are the curved surfaces in a region enclosed by a medium thick line, are designated as the measurement object curved surface of the shape model M1.

Note that a designation method of the measurement object curved surface is not limited to the above-described designation method, and the measurement object curved surface may be automatically designated by attaching in advance an attribute for designating the measurement object curved surface to the curved surface of the shape model stored in the shape model storage unit 101. As a result, when the measurement target curve generating unit 102 acquires the shape model stored in the shape model storage unit 101, the measurement object curved surface is automatically designated on the measurement object curved surface. After step S110 is executed, the procedure proceeds to step S120.

In step S120, the measurement target curve generating unit 102 generates the measurement target curve on the measurement object curved surface of the shape model. The measurement target curve represents successive positions on the measurement object curved surface measured by the measurement sensor 21. That is, in step S120, a measurement target curve generating step is performed for generating the measurement target curve that is the curve on the measurement object curved surface of the shape model.

The measurement target curve generating unit 102 generates a plane and generates an intersection line between the plane and the measurement object curved surface as the measurement target curve. Here, the plane may be any plane designated by an operator inputting information of a position of the plane and information of a direction of the plane to the path processing unit 12, or may be selected by an operator from among information of a plurality of planes prepared in advance in the path processing unit 12. The information of the plurality of planes may be stored in, for example, the shape model storage unit 101 or another component of the path processing unit 12 such as the measurement target curve generating unit 102. Also, not only one plane but a plurality of planes may be generated where, for example, one plane and a plurality of planes obtained by offsetting the one plane in the normal direction of the one plane at equal intervals may be generated. That is, as the plane, for example, one plane and a plurality of planes disposed in the normal direction of the one plane at equal intervals in the depth direction of the shape model may be generated.

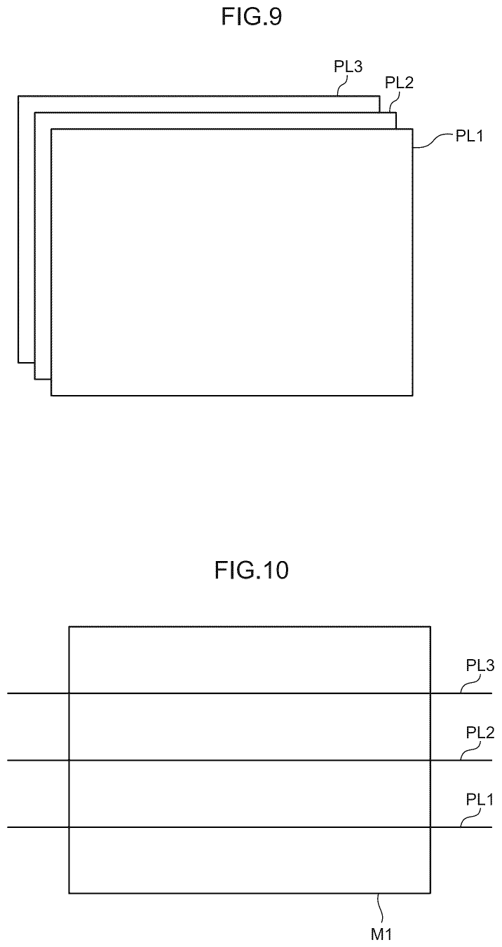

FIG. 8 is a diagram illustrating how the planes are generated in the shape model used in the measurement path generating device according to the first embodiment. FIG. 8 illustrates a state in which three planes including a first plane PL1, a second plane PL2, and a third plane PL3 are generated as the planes in the shape model M1. FIG. 9 is a diagram illustrating the planes illustrated in FIG. 8. FIG. 10 is a top view of FIG. 8. Note that in FIG. 10, the two concave shapes along the Y direction are omitted.

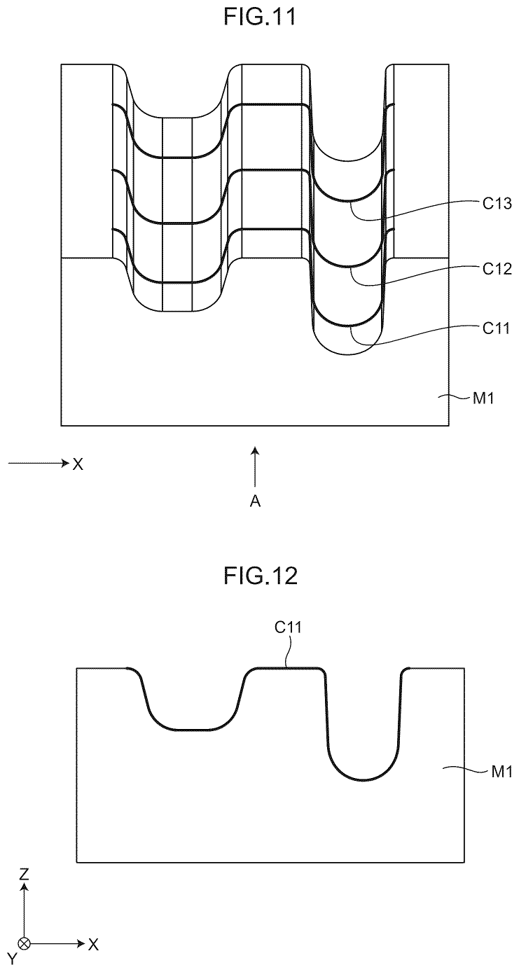

FIG. 11 is a perspective view illustrating a state in which the measurement target curves are generated on the measurement object curved surface of the shape model used in the measurement path generating device according to the first embodiment. FIG. 12 is a side view illustrating the state in which the measurement target curve is generated on the measurement object curved surface of the shape model used in the measurement path generating device according to the first embodiment. FIG. 11 illustrates the state in which a measurement target curve C11, a measurement target curve C12, and a measurement target curve C13 are generated on the shape model M1 as intersection lines between the planes PL1 to PL3 and the curved surface S2 to S14 as the measurement object curved surface designated in step S110. FIG. 12 illustrates the state in which the shape model M1 illustrated in FIG. 11 is viewed from the direction of the arrow A in FIG. 11.

Note that the measurement target curve may be generated not only by the above-described generation method but also on the basis of a shape element included in the shape model. The measurement target curve may be generated by, for example, using an edge curve of the shape model, which is one shape element included in the shape model, as the measurement target curve or performing an operation such as offsetting the edge curve or blending between the edge curves.

The measurement target curve generating unit 102 transmits the information of the shape model, the information of the measurement object curved surface, and the information of the measurement target curve to the reference point calculating unit 104. After step S120 is executed, the procedure proceeds to step S130.

In step S130, the reference point calculating unit 104 calculates the coordinate positions of the reference points on the measurement target curve and the normal directions of the measurement object curved surface at the reference points. That is, in step S130, a reference point calculating step is performed for obtaining the reference points, which are points on the measurement target curve, and the normal directions of the measurement object curved surface at the reference points. Hereinafter, the normal direction of the measurement object curved surface at the reference point may be simply referred to as the normal direction.

Specifically, the reference point calculating unit 104 samples points on the measurement target curve, and sets the sampled points as the reference points. As a method of sampling the points on the measurement target curve, for example, parameters corresponding to a start point and an end point of the measurement target curve are divided at equal intervals, so that positions on the measurement target curve can be calculated on the basis of the parameters and obtained as the reference points. Also, in order to obtain the reference points corresponding to the curvature of the measurement target curve, a chord error between a line segment connecting adjacent reference points and the measurement target curve may be determined in advance, and the reference points may be obtained on the measurement target curve so as to satisfy the chord error determined in advance.

Moreover, since the measurement target curve lies on the measurement object curved surface, the reference points calculated also lie on the measurement object curved surface. Thus, the reference point calculating unit 104 can calculate the normal directions at the positions of the reference points on the measurement object curved surface. At this time, in order to obtain the reference points corresponding to an amount of change in the normal directions of the measurement target curve, the amount of change in the normal directions between adjacent reference points may be obtained, and a reference point may be added on the measurement target curve such that a predetermined allowable angular change is satisfied.

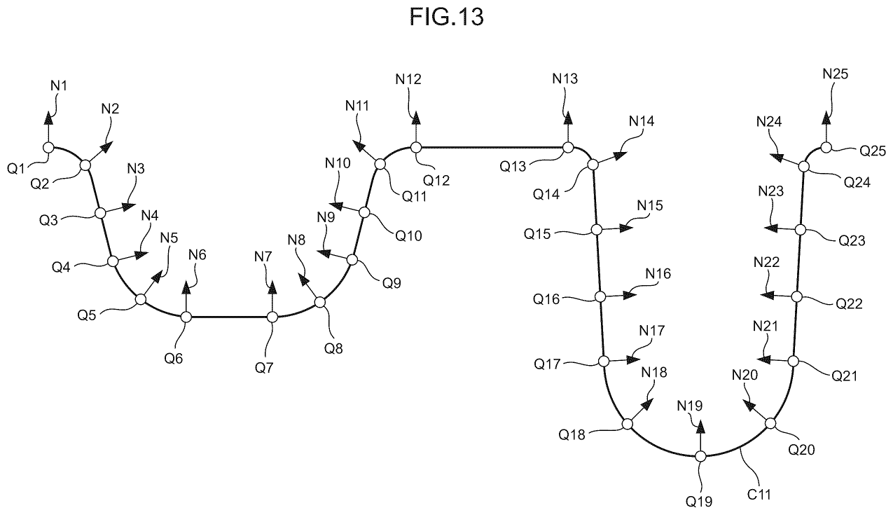

FIG. 13 is a diagram illustrating how the reference points and the normal directions of the measurement object curved surface at the reference points are calculated on the measurement target curve of the shape model used in the measurement path generating device according to the first embodiment. FIG. 13 illustrates how reference points Q1 to Q25 are calculated on the measurement target curve C11, and how normal directions N1 to N25 on the measurement object curved surface are calculated at the corresponding reference points. The normal direction N1 to the reference point N25 are the normal directions of the measurement object curved surface at the reference point Q1 to the reference point Q25.

In FIG. 13, circles indicate the reference points. Similar indication applies to the subsequent drawings. In FIG. 13, single-headed arrows indicate the normal directions of the measurement object curved surface at the reference points. In FIG. 13, for example, the normal direction of the measurement object curved surface at the position of the reference point Q1 on the measurement object curved surface is the normal direction N1. Similarly, the normal direction of the measurement object curved surface at the position of the reference point Q2 on the measurement object curved surface is the normal direction N2. The rest of the reference points and the normal directions correspond to each other similarly.

The reference point calculating unit 104 transmits the information of the shape model, the information of the measurement object curved surface, the information of the measurement target curve, the information of the coordinate positions of the reference points on the measurement target curve, and the information of the normal directions of the measurement object curved surface at the reference points to the measurement path generating unit 105. After step S130 is executed, the procedure proceeds to step S140.

In step S140, the measurement path generating unit 105 generates the measurement path satisfying measurement-performable conditions, the measurement path being the movement path of the measurement sensor 21 that performs measurement on the measurement target curve. The measurement path generating unit 105 generates the measurement path so as to satisfy the measurement-performable conditions. That is, in step S140, a measurement path generating step is performed for generating the measurement path, which is the movement path for performing measurement on the measurement target curve, on the basis of the reference points, the normal directions, the measurement-performable distance range that is the distance range where measurement can be performed between the measurement sensor 21 and the measurement target curve, and the measurement-performable angle range that is the relative angle range where measurement can be performed between the measurement direction of the measurement sensor 21 and the normal direction of the measurement object curved surface.

First, the measurement path generating unit 105 sets the measurement-performable distance range and the measurement-performable angle range as the measurement-performable conditions. The measurement path generating unit 105 sets the measurement-performable distance range and the measurement-performable angle range in accordance with measurement-performable condition setting information specifying specific ranges for the measurement-performable distance range and the measurement-performable angle range. The measurement-performable condition setting information is input to the measurement path generating unit 105 by an operator.

The measurement-performable distance range is a predetermined distance range where measurement can be performed between the measurement sensor 21 and the measurement target curve. The measurement-performable distance range is determined by the specifications of the measurement sensor 21.

The measurement-performable angle range is a predetermined relative angle range where measurement can be performed between the measurement direction of the measurement sensor 21 and the normal direction of the measurement object curved surface. The relative angle between the measurement direction of the measurement sensor 21 and the normal direction of the measurement object curved surface is an angle formed by the measurement direction of the measurement sensor 21 and the normal direction of the measurement object curved surface on a virtual plane including the measurement direction of the measurement sensor 21 and the normal direction of the measurement object curved surface. The measurement-performable distance range is determined by the specifications of the measurement sensor 21.

Then, the measurement path generating unit 105 determines the measurement-performable area, which is the area where the measurement sensor 21 can measure the measurement object 30, on the basis of the measurement-performable conditions. Here, the measurement direction of the measurement sensor 21 is the attitude of the measurement sensor 21. For example, when the measurement sensor 21 is the optical distance sensor, the direction of the output light emitted from the optical distance sensor toward the measurement object 30 may be set as the measurement direction. Hereinafter, the measurement direction of the measurement sensor 21 may be simply referred to as the measurement direction.

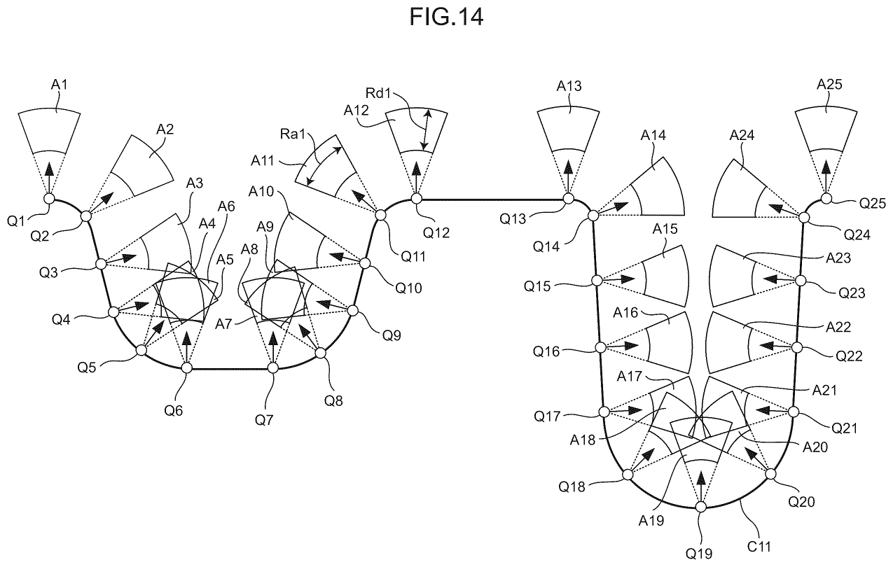

FIG. 14 is a diagram illustrating an example of the measurement-performable areas determined on the basis of the measurement-performable distance range and the measurement-performable angle range in the shape model used in the measurement path generating device according to the first embodiment. Note that the single-headed arrows in FIG. 14 indicate, as in FIG. 13, the normal directions of the measurement object curved surface at the reference points.

In FIG. 14, a measurement-performable distance range Rd1 and a measurement-performable angle range Ra1 are set as predetermined values, and on the basis of the measurement-performable distance range Rd1 and the measurement-performable angle range Ra1, a measurement-performable area A1 to a measurement-performable area A25 are illustrated as areas where the measurement sensor 21 can perform measurement for measuring the reference point Q1 to the reference point Q25, respectively. When the measurement sensor 21 performs measurement, the measurement sensor 21 can be disposed in each of the measurement-performable area A1 to the measurement-performable area A25.

Note that in FIG. 14, the measurement-performable distance range Rd1 and the measurement-performable angle range Ra1 are illustrated on an XZ plane, that is, the measurement-performable distance range Rd1 and the measurement-performable angle range Ra1 are illustrated in two dimensions, but the measurement-performable distance range Rd1 and the measurement-performable angle range Ra1 can be set in three dimensions. Thus, a measurement-performable distance and a measurement-performable angle need only be determined in three dimensions.

At this time, in the measurement path generating unit 105, the measurement-performable distance range and the measurement-performable angle range, which are the measurement-performable conditions, may be set on the basis of the measurement environment information that is the information regarding the measurement environment stored in the measurement environment information storage unit 106. The measurement environment information may be stored in advance in the measurement environment information storage unit 106, or may be input to the measurement environment information storage unit 106 by an operator. The measurement path generating unit 105 can use, as the measurement environment information, at least one of: the type of the measurement sensor 21; the measurement method of the measurement sensor 21; the wavelength of output light of the measurement sensor 21; the focal length of the measurement sensor 21; the measurement cycle of the measurement sensor 21; the material of the measurement object 30; and the surface roughness of the measurement object 30.

The measurement environment information is the information including various conditions regarding the measurement environment when the measurement sensor 21 measures the measurement object 30. The measurement environment information can include, for example, information that the type of the measurement sensor 21 is the optical distance sensor, and information that the measurement method of the measurement sensor 21 is frequency scanning interferometry as disclosed in Japanese Patent Application Laid-open No. 2017-191815, for example. An optical distance measuring apparatus using frequency scanning interferometry, which is one of methods for measuring the distance to the measurement object using light, emits frequency sweeping light whose frequency changes with time toward the measurement object, and receives the frequency sweeping light reflected by the measurement object as reflected light. The optical distance measuring apparatus uses a portion of the frequency sweeping light before being emitted to the measurement object as reference light, and measures the distance to the measurement object on the basis of interference light between the reference light and the reflected light.

Furthermore, the measurement environment information can include, for example, information of the shape of the measurement sensor 21, the wavelength of the output light of the measurement sensor 21, and the focal length of the measurement sensor 21 that are the specifications of the measurement sensor 21. The measurement environment information can also include the information of the material of the measurement object 30 and the information of the surface roughness of the measurement object 30 that are the specifications of the measurement object 30. For the surface roughness of the measurement object 30, a design target value may be determined in advance for each curved surface of the shape model.

Here, in accordance with the specifications of the measurement sensor 21 or the specifications of the measurement object 30 described above, the measurement path generating unit 105 can, for example, predict in advance the intensity of the reflected light obtained when the output light emitted toward the measurement object 30 is reflected by the measurement object 30, and can determine an allowable relative angle for obtaining sufficient reflected light in the measurement sensor 21. As a result, the measurement path generating unit 105 can appropriately set the measurement-performable distance range and the measurement-performable angle range on the basis of the measurement environment information. Note that the measurement-performable distance range and the measurement-performable angle range need not be fixed values and may be variable values expressed by mathematical expressions. For example, the measurement-performable distance range may be changed in accordance with the relative angle between the measurement direction and the normal direction of the curved surface.

Subsequently, the measurement path generating unit 105 calculates the measurement position and the measurement direction of the measurement sensor 21 for measuring each reference point. Conveniently, the measurement path generating unit 105 need only determine, in the measurement-performable area determined for each reference point, the measurement position and the measurement direction to be the center of the measurement-performable distance range and be the measurement direction facing the normal direction of the reference point, respectively. Here, the normal direction of the reference point facing the measurement direction means that the normal direction of the reference point and the measurement direction are located on the same line and face each other.

Note that, as described above, since the measurement-performable distance range Rd1 and the measurement-performable angle range Ra1 can be set in three dimensions, the measurement position and the measurement direction of the measurement sensor 21 also need only be determined in a three-dimensional range.

At this time, the interference determination unit 108 determines the presence or absence of interference between the measurement sensor 21 and the shape model of the measurement object 30. The interference determination unit 108 acquires, from the measurement path generating unit 105, the information of the shape model, the information of the measurement object curved surface, the information of the measurement target curve, the information of the coordinate positions of the reference points on the measurement target curve, the information of the normal directions of the measurement object curved surface at the reference points, the information of the specifications of the measurement sensor 21, the information of the shape of the measurement sensor 21, and the information of the measurement position and the measurement direction of the measurement sensor 21 for measuring each reference point, and determines the presence or absence of interference between the measurement sensor 21 and the shape model of the measurement object 30 on the basis of these pieces of information. The interference determination unit 108 transmits, to the measurement path generating unit 105, a determination result for each reference point regarding the presence or absence of interference between the measurement sensor 21 and the shape model of the measurement object 30.

Then, in a case where the measurement sensor 21 and the shape model of the measurement object 30 are determined to interfere with each other, the measurement path generating unit 105 corrects the measurement position and the measurement direction of the measurement sensor 21 so as to avoid the interference between the measurement sensor 21 and the shape model of the measurement object 30.

Here, when correcting one set of the measurement position and the measurement direction, the measurement path generating unit 105 adjusts the measurement position and the measurement direction around the corrected measurement position and measurement direction in order to prevent the occurrence of a sharp movement of the measurement sensor 21. That is, when correcting the measurement position and the measurement direction of the measurement sensor 21 for one of the reference points, the measurement path generating unit 105 adjusts the measurement position and the measurement direction of the measurement sensor 21 for the reference point around the reference point for which the measurement position and the measurement direction have been corrected.

For example, the measurement path generating unit 105 can adjust the measurement position and the measurement direction of the measurement sensor 21 such that the direction of movement of each drive axis of the machine tool 20 is not reversed, and can adjust the measurement position and the measurement direction of the measurement sensor 21 such that a ratio of an amount of movement of a linear axis to an amount of movement of a rotary axis of the machine tool 20 does not exceed a predetermined value.

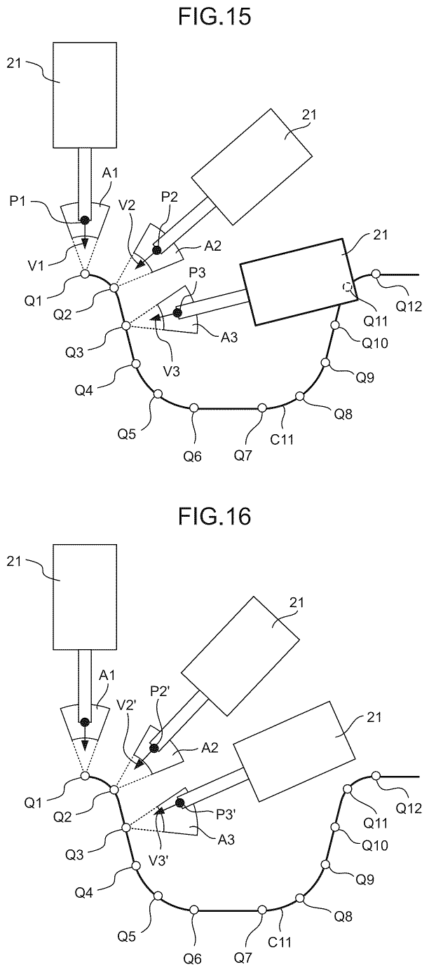

With reference to FIGS. 15 to 17, an example of a method of calculating the measurement positions and the measurement directions of the measurement sensor 21 for measuring the reference points Q1 to Q3 will be described. Note that in FIGS. 15 to 17, black circles indicate the measurement positions of the measurement sensor 21. In FIGS. 15 to 17, single-headed arrows indicate the measurement directions of the measurement sensor 21.

FIG. 15 is a first diagram illustrating how the measurement positions and the measurement directions of the measurement sensor are calculated for measuring the reference points used in the measurement path generating device according to the first embodiment. FIG. 15 illustrates a state in which the measurement path generating unit 105 calculates, for the reference point Q1 to the reference point Q3, the measurement positions of the measurement sensor 21 as a measurement position P1 to a measurement position P3, respectively, and the measurement directions of the measurement sensor 21 as a measurement direction V1 to a measurement direction V3, respectively, such that the measurement positions are each at the center of the measurement-performable distance range and that the measurement directions each face the normal direction of the corresponding reference point. Here, in FIG. 15, when the measurement position P3 and the measurement direction V3 of the measurement sensor 21 for measuring the reference point Q3 are set, interference occurs between the curved surface of the shape model M1 and the measurement sensor 21. That is, in FIG. 15, when the measurement position P3 and the measurement direction V3 of the measurement sensor 21 for measuring the reference point Q3 are set, interference occurs between the measurement target curve C11, which is the measurement target curve on the measurement object curved surface of the shape model M1, and the measurement sensor 21.

FIG. 16 is a second diagram illustrating how the measurement positions and the measurement directions of the measurement sensor are calculated for measuring the reference points used in the measurement path generating device according to the first embodiment. FIG. 16 illustrates a state in which the measurement position P3 is adjusted to a measurement position P3′ and the measurement direction V3 is adjusted to a measurement direction V3′ in order to avoid interference between the measurement sensor 21 and the curved surface of the shape model when the measurement position P3 and the measurement direction V3 of the measurement sensor 21 are set for measuring the reference point Q3.

In addition, here, in order to prevent the occurrence of a sharp movement of the measurement sensor 21 due to the adjustment of the measurement position and the measurement direction of the measurement sensor 21, the measurement position P2 and the measurement direction V2 of the measurement sensor 21 for measuring the reference point Q2 are adjusted. That is, FIG. 16 illustrates a state in which, for the reference point Q2, the measurement position P2 is adjusted to a measurement position P2′ and the measurement direction V2 is adjusted to a measurement direction V2′.

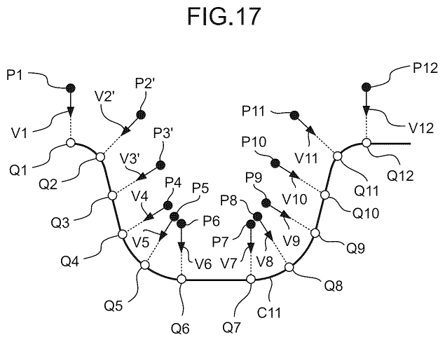

FIG. 17 is a third diagram illustrating how the measurement positions and the measurement directions of the measurement sensor are calculated for measuring the reference points used in the measurement path generating device according to the first embodiment. FIG. 17 illustrates a state in which the measurement positions of the measurement sensor 21 for measuring the reference point Q1 to the reference point Q12 are calculated as P1 to P12, respectively, and the measurement directions of the measurement sensor 21 for measuring the reference point Q1 to the reference point Q12 are calculated as V1 to V12, respectively.

Meanwhile, in a case where the measurement sensor 21 and the shape model of the measurement object 30 are determined to interfere with each other, the interference may not be avoided even when the measurement path generating unit 105 corrects the measurement position and the measurement direction of the measurement sensor 21 within the measurement-performable area for the corresponding reference point. In such a case, the measurement path generating unit 105 does not calculate the measurement position and the measurement direction of the measurement sensor 21 for measuring the reference point, but stores the reference point as an unmeasurable reference point.

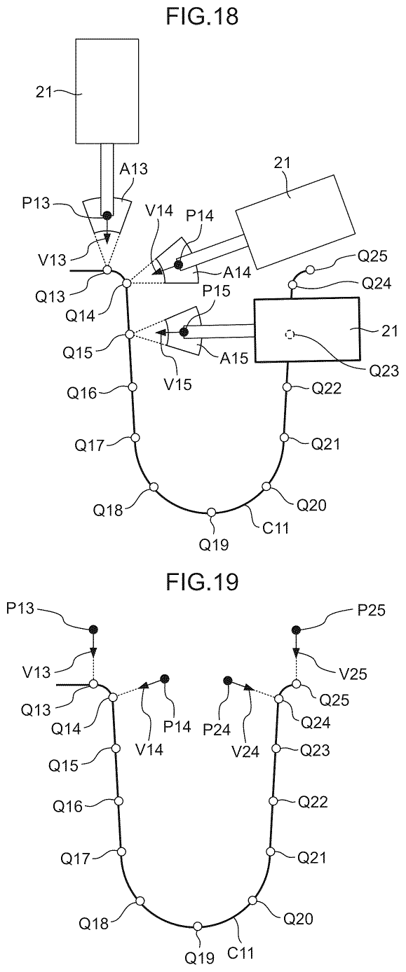

With reference to FIGS. 18 and 19, an example of a method of calculating the measurement positions and the measurement directions of the measurement sensor 21 for measuring the reference points Q13 to Q25 will be described. Note that in FIGS. 18 and 19, black circles indicate the measurement positions of the measurement sensor 21. In FIGS. 18 and 19, single-headed arrows indicate the measurement directions of the measurement sensor 21.

FIG. 18 is a fourth diagram illustrating how the measurement positions and the measurement directions of the measurement sensor are calculated for measuring the reference points used in the measurement path generating device according to the first embodiment. FIG. 18 illustrates a state in which the measurement path generating unit 105 calculates, for the reference point Q13 to the reference point Q15, the measurement positions of the measurement sensor 21 as a measurement position P13 to a measurement position P15, respectively, and the measurement directions of the measurement sensor 21 as a measurement direction V13 to a measurement direction V15, respectively, such that the measurement positions are each at the center of the measurement-performable distance range and that the measurement directions each face the normal direction of the corresponding reference point.

Here, in FIG. 18, when the measurement position P15 and the measurement direction V15 of the measurement sensor 21 for measuring the reference point Q15 are set, interference occurs between the curved surface of the shape model M1 and the measurement sensor 21. That is, in FIG. 18, when the measurement position P15 and the measurement direction V15 of the measurement sensor 21 for measuring the reference point Q3 are set, interference occurs between the measurement target curve C11, which is the measurement target curve on the measurement object curved surface of the shape model M1, and the measurement sensor 21.

At this time, even when the measurement position and the measurement direction of the measurement sensor 21 for measuring the reference point Q15 are adjusted in an attempt to avoid the interference between the measurement sensor 21 and the curved surface of the shape model M1, the measurement position and the measurement direction of the measurement sensor 21 that can avoid the interference are not found within the measurement-performable area A15 for the reference point Q15 illustrated in FIG. 18. The measurement path generating unit 105 does not calculate the measurement position and the measurement direction of the measurement sensor 21 for measuring the reference point, but stores the reference point Q15 as an unmeasurable reference point. Similarly, for the reference point Q16 to the reference point Q23, the measurement positions and the measurement directions that can avoid the interference between the measurement sensor 21 and the curved surface of the shape model M1 are not found, so that the measurement path generating unit 105 does not calculate the measurement positions and the measurement directions of the measurement sensor 21 for measuring the reference points, but stores the reference point Q16 to the reference point Q23 as unmeasurable reference points.

FIG. 19 is a fifth diagram illustrating how the measurement positions and the measurement directions of the measurement sensor are calculated for measuring the reference points used in the measurement path generating device according to the first embodiment. FIG. 19 illustrates a state in which the measurement path generating unit 105 calculates, for the reference points Q13, Q14, Q24, and Q25 being the reference points that can be measured by the measurement sensor 21, the measurement positions of the measurement sensor 21 as the measurement position P13, the measurement position P14, a measurement position P24, and a measurement position P25, respectively, and the measurement directions of the measurement sensor 21 as the measurement direction V13, the measurement direction V14, a measurement direction V24, and a measurement direction V25, respectively, such that the measurement positions are each at the center of the measurement-performable distance range and that the measurement directions each face the normal direction of the corresponding reference point.

Then, the measurement path generating unit 105 generates the measurement path by sequentially connecting the measurement positions calculated and setting the measurement directions calculated at the corresponding measurement positions as the measurement directions of the measurement sensor 21 at the measuring positions. At this time, the measurement path generating unit 105 distinguishes a path between the reference points stored as the unmeasurable reference points from the measurement path. That is, the measurement path generating unit 105 generates a connected path in which the measurement position P13, the measurement position P14, the measurement position P24, and the measurement position P25 are sequentially connected, where the reference point Q15 to the reference point Q23 stored as the unmeasurable reference points are not connected and are excluded from the connected path. Note that the measurement path generating unit 105 may generate a path such that the reference points stored as the unmeasurable reference points are not directly connected and that the measurement sensor 21 is retracted in a direction in which interference does not occur between the measurement sensor 21 and the measurement object 30 and then approaches the next reference point.

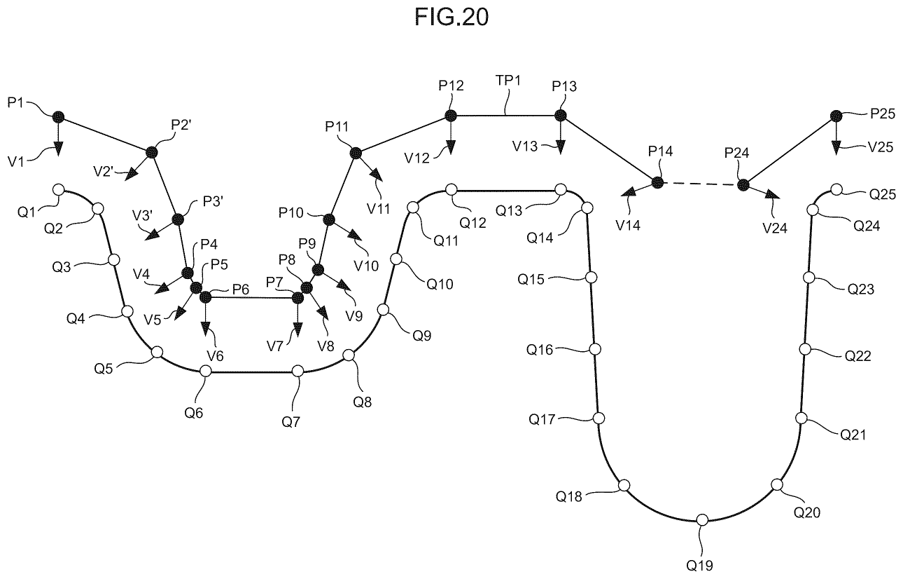

FIG. 20 is a diagram illustrating how the measurement path is generated in the measurement path generating device according to the first embodiment. FIG. 20 illustrates how a measurement path TP1 is generated in which the measurement position P1 to the measurement position P14, the measurement position P24, and the measurement position P25 that have been calculated are sequentially connected, and the measurement direction V1 to the measurement direction V14, the measurement direction V24, and the measurement direction V25 are set as the measurement directions at the corresponding measurement positions, respectively. Here, since the reference point Q15 to the reference point Q23 stored as the unmeasurable reference points exist between the measurement position P14 and the measurement position P24, a path connecting the measurement position P14 and the measurement position P24 is distinguished from the rest.

In step S140 described above, the measurement path generating unit 105 generates information of the measurement path including a plurality of the measurement positions, a line connecting the measurement positions, and the measurement directions at the corresponding measurement positions. Moreover, in a case where the reference point stored as the unmeasurable reference point exists, the measurement path generating unit 105 generates, as a part of the information of the measurement path, information of a measurement-unperformable section, which is a section of the measurement target curve where the unmeasurable reference point exists, and information of a detour measurement path bypassing the measurement-unperformable section. That is, the measurement path generating unit 105 determines the measurement-unperformable section where the measurement path cannot be generated on the measurement target curve, and generates the measurement path including the detour measurement path that avoids the measurement-unperformable section.

The measurement path generated as described above may satisfy requirements that a plurality of the measurement positions is included, the measurement-unperformable section is avoided at all the measurement positions, and an error between a line segment connecting positions on the measurement target curve measured at consecutive measurement positions and the measurement target curve satisfies a predetermined allowable error.

The measurement path generating unit 105 transmits the information of the shape model, the information of. the measurement object curved surface, the information of the measurement target curve, the information of the coordinate positions of the reference points on the measurement target curve, the information of the normal directions of the measurement object curved surface at the reference points, and the information of the measurement path to the display unit 107. After step S140 is executed, the procedure proceeds to step S150.

In step S150, the display unit 107 displays the measurement path, and the measurement program is output. Specifically, the shape model which is stored in the shape model storage unit 101 and for which the measurement path is generated, the measurement target curve generated by the measurement target curve generating unit 102, and the measurement path generated by the measurement path generating unit 105 for measuring the measurement target curve are displayed on a screen of the display unit 107. At this time, a plurality of the measurement target curves and a plurality of the measurement paths may be displayed. In this case, the measurement target curve and the measurement path are displayed in association with each other such that the measurement paths corresponding to the respective measurement target curves are distinguished from each other.

Here, displaying the measurement target curve and the measurement path in association with each other may be, for example, displaying the measurement path associated with the measurement target curve and the measurement path not associated with the measurement target curve such that the measurement paths are distinguishable by an operator viewing a display screen of the display unit 107. A method of displaying the measurement target curve and the measurement path in association with each other includes, for example, displaying the measurement target curve and the associated measurement path in the same color, displaying the measurement target curve and the associated measurement path using the same line width, displaying the measurement target curve and the associated measurement path using the same line type such as a broken line or a dotted line, and the like.

Moreover, in the measurement path, a plurality of the measurement positions, a line connecting the measurement positions, and the measurement directions at the corresponding measurement positions are displayed. Also, in a case where the reference point stored as the unmeasurable reference point exists, the measurement-unperformable section that is the section of the measurement target curve where the unmeasurable reference point exists and the detour measurement path bypassing the measurement-unperformable section are displayed distinctively from the measurement path.

Here, a method of displaying the measurement-unperformable section distinctively from the measurement target curve includes, for example, a method of displaying the measurement-unperformable section in a color different from that of the section of the measurement target curve that is not the measurement-unperformable section, a method of displaying the measurement-unperformable section with a line width different from that of the section of the measurement target curve that is not the measurement-unperformable section, a method of displaying the measurement-unperformable section with a line type different from that of the section of the measurement target curve that is not the measurement-unperformable section, and the like.

Similarly, a method of displaying the detour measurement path distinctively from the measurement path includes, for example, a method of displaying the detour measurement path in a color different from that of the measurement path that is not the detour measurement path, a method of displaying the detour measurement path with a line width different from that of the measurement path that is not the detour measurement path, a method of displaying the detour measurement path with a line type different from that of the measurement path that is not the detour measurement path, and the like.

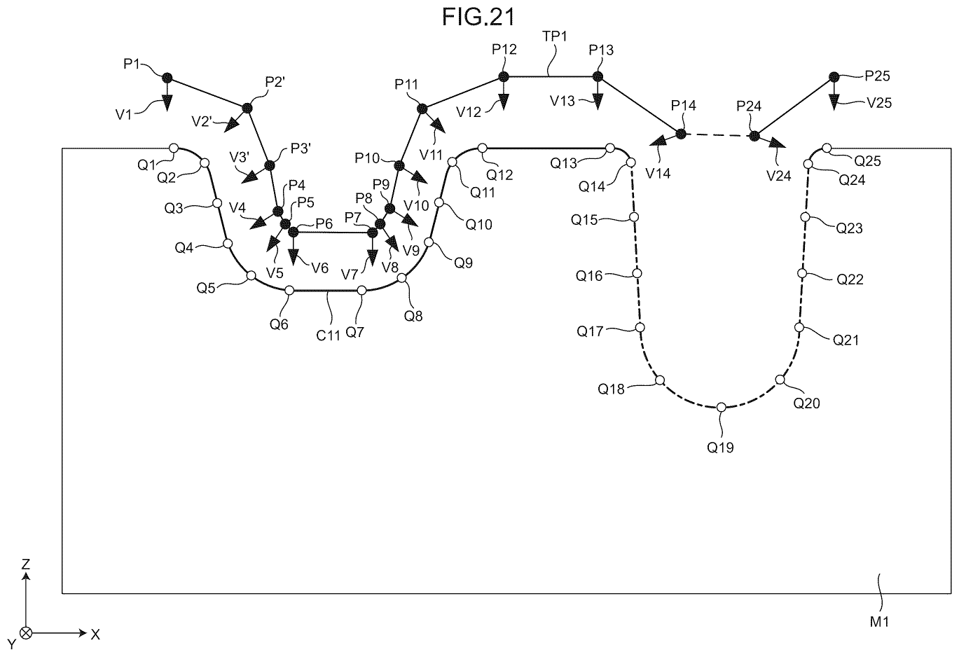

FIG. 21 is a diagram illustrating how the measurement path is displayed on the display unit of the measurement path generating device according to the first embodiment. Specifically, FIG. 21 illustrates the shape model M1, the measurement target curve C11, and the measurement path TP1 for measuring the measurement target curve C11 that are displayed on the display unit 107 of the measurement path generating device 10. FIG. 21 illustrates a state in which the measurement positions P1 to P14, P24, and P25, the line connecting the measurement positions, and the measurement directions V1 to V14, V24, and V25 at the corresponding measurement positions are displayed as the measurement path TP1.

Moreover, FIG. 21 illustrates a state in which the path connecting the measurement position P14 and the measurement position P24, which is the measurement path between the reference point Q15 and the reference point Q23 stored as the unmeasurable reference points, is distinctively displayed using a broken line. Furthermore, FIG. 21 illustrates a state in which the section where the reference points Q15 to Q23 stored as the unmeasurable reference points exist on the measurement target curve C11 is distinctively displayed using a dash-dotted line.

Subsequently, the measurement program output unit 109 generates and outputs the measurement program on the basis of the measurement path generated by the measurement path generating unit 105. At this time, the measurement program output unit 109 stores in advance the configuration of the drive axes of the machine tool 20 to generate and output the measurement program describing the command for relatively moving the measurement sensor 21 and the measurement object 30 along the measurement path on the basis of the configuration.

The measurement program output unit 109 generates the measurement program describing the command for relatively moving the measurement sensor 21 and the measurement object 30 along the measurement path, which is generated by the measurement path generating unit 105, on the basis of the configuration of the drive axes of the machine tool 20. Moreover, in a case where the measurement path generating unit 105 determines the measurement-unperformable section in which the measurement path cannot be generated on the measurement target curve, the measurement program output unit 109 generates a measurement program describing a command corresponding to the measurement path on the measurement-unperformable section distinctively from other commands.

The measurement program is described in a file in a predetermined format by a character string such as a G code or a macro sentence. Here, the G code is, for example, a command code for performing positioning, linear interpolation, circular interpolation, plane designation, and the like by numerical control. At this time, in a case where the measurement path generating unit 105 determines the measurement-unperformable section in which the measurement path cannot be generated on the measurement target curve, the command corresponding to the measurement path included in the measurement-unperformable section may be described distinctively from the command corresponding to the section in which the measurement path is generated. A method of distinctively describing the command includes, for example, describing the command for the measurement path included in the measurement-unperformable section using a special G code, an M code, or the like.

Furthermore, the measurement program output unit 109 may acquire the measurement environment information from the measurement environment information storage unit 106, calculate a condition such as a feed speed for moving the measurement sensor 21 on the basis of the measurement environment information, and describe the calculated condition in the measurement program. For example, on the basis of the measurement cycle of the measurement sensor that is the measurement environment information, a relative speed of movement between the measurement sensor and the measurement object 30 may be determined according to the curvature of the measurement target curve or the like such that the measurement is performed at regular intervals for each measurement cycle on the measurement target curve. Here, performing the measurement on the measurement target curve can be rephrased as, for example, performing the measurement along the measurement target curve, or performing the measurement so as to follow the reference points located on the measurement target curve. In addition, the measurement being performed at regular intervals for each measurement cycle on the measurement target curve means that the interval between the positions on the measurement target curve measured for each measurement cycle is constant.

With the execution of step S150, the series of measurement path processing on the measurement path generating device 10 is completed.

The measurement path generating device 10 according to the first embodiment described above can perform the measurement in the measurement direction that is not perpendicular to the measurement object curved surface of the measurement object 30, thereby achieving an effect of generating the measurement path that can reduce the time required for measuring the measurement object 30. Also, the measurement path generating device can generate the measurement path for appropriately measuring the measurement object 30 while avoiding interference between the measurement object curved surface of the measurement object 30 and the measurement sensor 21, thereby achieving an effect of generating the measurement path that can reduce the effort of an operator for correcting the measurement path.

The measurement target curve generating unit 102 can easily designate the measurement target curve by generating the plane and using the intersection line between the measurement object curved surface of a measurement model and the plane, thereby achieving an effect of reducing the effort for generating the measurement target curve.

The measurement path generating unit 105 determines the measurement-unperformable section in which the measurement path cannot be generated on the measurement target curve, and generates the detour measurement path for avoiding the measurement-unperformable section to be able to generate the measurement path that enables measurement of only the section where measurement can be performed on the measurement object 30, thereby achieving an effect of reducing the effort of an operator for correcting the measurement path.

In the display unit 107, the measurement target curve and the measurement path for performing measurement on the measurement target curve are displayed in association with each other, so that the correspondence between the measurement target curve and the measurement path can be presented to an operator in an easy-to-understand way, which has an effect of reducing the effort required of the operator to check the measurement path.

In the display unit 107, when the measurement-unperformable section in which the measurement path cannot be generated exists on the measurement target curve, the measurement-unperformable section is displayed distinctively from the measurement path, which has an effect of reducing the effort required of an operator to see whether not measurement can be appropriately performed with the measurement path.

The measurement program output unit 109 outputs the measurement program describing the command for relatively moving the measurement sensor 21 and the measurement object 30 along the measurement path on the basis of the configuration of the drive axes of the machine tool 20, thereby achieving an effect of reducing the effort of an operator for correcting the measurement program in accordance with the configuration of the drive axes of the machine tool 20.

In a case where the measurement path generating unit 105 determines the measurement-unperformable section in which the measurement path cannot be generated on the measurement target curve, the measurement program output unit 109 outputs the measurement program describing the command corresponding to the measurement path on the measurement-unperformable section distinctively from the other commands. Thus, the machine tool 20 performs on-machine measurement using the measurement program, thereby achieving an effect of performing measurement only in the section where the measurement object 30 can be appropriately measured. In addition, there is an effect that an operator can reduce the effort to correct the measurement program for the section where measurement cannot be performed.

The measurement path generating unit 105 uses, as the measurement environment information, the information that the type of the measurement sensor 21 is the optical distance sensor as the measurement environment information to be able to easily generate the measurement path that enables appropriate measurement of the measurement object 30 in a case where the optical distance sensor of a non-contact type is used, thereby achieving an effect of reducing the effort of creating the measurement program.

The measurement path generating unit 105 uses, as the measurement environment information, the information that the measurement sensor 21 is the optical distance sensor using the measurement method of measuring the distance to the measurement object 30 by frequency scanning interferometry, and thus can generate the measurement path that enables appropriate measurement of the measurement object 30 in a case where on-machine measurement is performed by the measurement sensor 21, thereby achieving an effect of reducing the effort of creating the measurement program.

The measurement path generating unit 105 determines the measurement-performable distance range and the measurement-performable angle range on the basis of the measurement environment information, so that the measurement-performable distance range and the measurement-performable angle range are determined in accordance with the measurement environment, and the measurement path that enables appropriate measurement of the measurement object 30 can be generated in accordance with the condition of the measurement sensor or the measurement object 30, which has an effect of reducing the effort of correcting the measurement path.

The measurement path generating unit 105 uses, as the measurement environment information, at least one of the type of the measurement sensor 21, the measurement method of the measurement sensor 21, the wavelength of output light of the measurement sensor 21, the focal length of the measurement sensor 21, the measurement cycle of the measurement sensor 21, the material of the measurement object 30, and the surface roughness of the measurement object 30, thereby being able to generate the measurement path that enables measurement of the measurement object 30 with high accuracy in accordance with these piece of the measurement environment information, and achieving an effect of reducing the effort of correcting the measurement path.

The measurement path generating unit 105 can determine, according to the measurement cycle of the measurement sensor 21 among the measurement environment information, the relative speed of movement between the measurement sensor 21 and the measurement object 30 such that the interval between the positions on the measurement target curve where measurement is performed is constant for each measurement cycle, and can include information of the speed of movement in the measurement path. As a result, the measurement path generating unit 105 can perform measurement on the measurement target curve at appropriate intervals, and achieves an effect of generating the measurement path with which a highly accurate measurement result can be obtained with small variations in the measurement intervals. Then, the measurement program output unit 109 can generate the measurement program describing the speed of movement on the basis of the measurement path including the information of the speed of movement.

The measurement system 1 according to the first embodiment described above determines the measurement-performable distance range and the measurement-performable angle range on the basis of environment information regarding the machine tool 20, the measurement sensor 21, and the measurement object 30, thereby being able to perform measurement with the measurement path optimal for the environment where the measurement is performed, and achieving an effect of obtaining an appropriate measurement result without spending effort.

Therefore, the measurement path generating device 10 and the measurement system 1 according to the first embodiment achieve an effect of generating the measurement path that enables the on-machine measurement of the measurement object 30 with high accuracy while reducing the time required for measuring the measurement object 30 and the effort required for measuring the measurement object 30.

### Second Embodiment

A second embodiment will describe another function of the measurement path generating device 10 according to the first embodiment. In the second embodiment as well, the measurement path generating device 10 basically operates according to the flowchart illustrated in FIG. 4 described above. Hereinafter, the operations of the measurement path generating device 10 that are different from those of the first embodiment will be described. The other operations of the measurement path generating device 10 are similar to those of the first embodiment, and thus will not be described.

In the second embodiment, in step S130, the reference point calculating unit 104 calculates coordinate positions of reference points on a measurement target curve and normal directions of a measurement object curved surface at the reference points. At this time, in a case where a tangent is discontinuous as in a corner on the measurement target curve, the reference point calculating unit 104 calculates two reference points at that position and normal directions at the corresponding reference points.

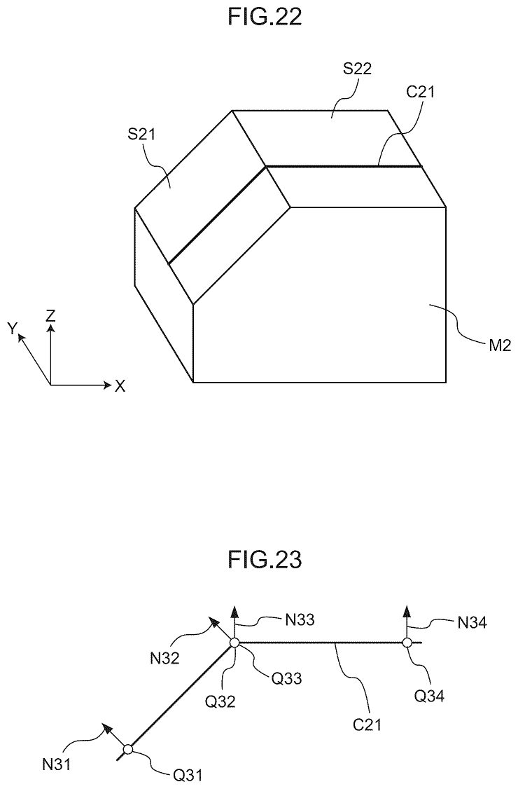

FIG. 22 is a perspective view illustrating a state in which the measurement target curve is generated on the measurement object curved surface of a shape model used by a measurement path generating device in the second embodiment. FIG. 22 illustrates a state in which a measurement target curve C21 is generated on a curved surface S21 generated on a shape model M2 and on a curved surface S22 generated on the shape model M2. Here, the tangent of the measurement target curve C21 is discontinuous at the boundary between the curved surface S21 and the curved surface S22.

FIG. 23 is a diagram illustrating how the reference points and the normal directions of the measurement object curved surface at the reference points are calculated on the measurement target curve of the shape model used by the measurement path generating device in the second embodiment. FIG. 23 illustrates how reference points Q31 to Q34 are calculated on the measurement target curve C21, and how normal directions N31 to 34 on the measurement object curved surface are calculated at the Corresponding reference points. Here, at the position where the tangent of the measurement target curve C21 is discontinuous, the reference point Q32 and the reference point Q33 are calculated as the two reference points where, at the reference point Q32, the normal direction N32 calculated from the measurement object curved surface S21 is illustrated, and at the reference point Q33, the normal direction N33 calculated from the measurement object curved surface S22 is illustrated.

When the shape model M2 is out by a plane passing through the measurement target curve C21, the tangent of the measurement target curve C21 is discontinuous at a corner that is an intersection of a line segment from the reference point Q31 to the reference point Q32 and a line segment from the reference point line segment Q33 to the reference point Q34. That is, a derivative of the line segment from the reference point Q31 to the reference point Q32 and a derivative of the line segment from the reference point line segment Q33 to the reference point Q34 are different at Q32 and 33Q at the corner that is the intersection of the two line segments.

In the second embodiment, in step S140, the measurement path generating unit 105 generates a measurement path with which measurement is performed in a plurality of measurement directions in a case where the measurement-performable condition is satisfied and the normal directions of the adjacent reference points change beyond a predetermined angle range. Here, the measurement path with which measurement is performed in the plurality of measurement directions is a measurement path with which measurement is performed by dividing a portion including two of the reference points of the measurement path into a plurality of sections and setting a different measurement direction for each of the divided sections.

The change in the normal directions of the adjacent reference points beyond the predetermined angle range can be rephrased as a change in the angle formed by the normal directions of the two adjacent reference points beyond the predetermined angle range. The angle formed by the normal directions of the two adjacent reference points is an angle formed by the normal directions of the two reference points on a plane including the normal directions of the two adjacent reference points.

Here, the predetermined angle range is set so as to prevent or reduce an increase in a measurement error caused by, for example, occurrence of abrupt acceleration/deceleration of the rotary axis of the machine tool 20 due to a rapid change in the measurement direction of the measurement sensor 21, or a large fluctuation in the intensity of reflected light due to a rapid change in the normal direction of the curved surface during measurement by the optical distance sensor. That is, the predetermined angle range may be specifically determined from the specifications of the measurement sensor 21 or the machine tool 20.

The measurement path generating unit 105 first determines the measurement-performable areas as in the case of the first embodiment. Subsequently, the measurement path generating unit 105 calculates, as in the case of the first embodiment, the measurement position and the measurement direction of the measurement sensor for measuring each reference point. Conveniently, as in the case of the first embodiment, the measurement path generating unit 105 need only determine, in the measurement-performable area determined for each reference point, the measurement position and the measurement direction to be the center of the measurement-performable distance range and be the measurement direction facing the normal direction of the reference point, respectively.

Here, the measurement path generating unit 105 checks an amount of change in the normal directions of the measurement object curved surface at the adjacent reference points at the position where the tangent is discontinuous on the measurement target curve. At this time, in a case where the amount of change in the normal directions of the measurement object curved surface at the adjacent reference points is beyond the predetermined angle range, the measurement path generating unit 105 calculates, on the basis of two of the measurement-performable areas corresponding to the two reference points, a measurement direction in which the two measurement-performable areas can be passed without changing the measurement direction of the measurement sensor 21. Specifically, a common portion between the measurement-performable angle ranges of the two measurement-performable areas is obtained, and the measurement direction need only be set within the angle range of the common portion. Then, the measurement direction calculated here is determined as the measurement direction for measuring the reference points.

Then, the measurement path generating unit 105 generates the measurement path by sequentially connecting the measurement positions calculated and setting the measurement directions calculated at the corresponding measurement positions as the measurement directions of the measurement sensor 21.

Hereinafter, a description will be given of a specific example of the case where the measurement path generating device calculates the measurement positions and the measurement directions of the measurement sensor in the second embodiment.

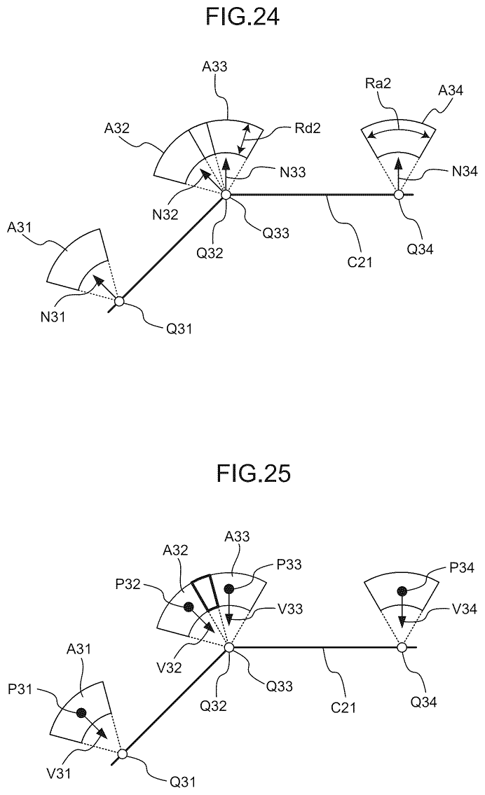

FIG. 24 is a diagram illustrating an example of measurement-performable areas determined on the basis of a measurement-performable distance range and a measurement-performable angle range in the shape model used by the measurement path generating device in the second embodiment. In FIG. 24, a measurement-performable distance range Rd2 and a measurement-performable angle range Ra2 are set as predetermined values, and on the basis of the measurement-performable distance range Rd2 and the measurement-performable angle range Ra2, a measurement-performable area A31 to a measurement-performable area A34 are illustrated as areas where the measurement sensor 21 can perform measurement for measuring the reference point Q31 to the reference point Q34, respectively.

In FIG. 24, the measurement-performable distance range Rd2 and the measurement-performable angle range Ra2 are illustrated in two dimensions, but the measurement-performable distance range Rd2 and the measurement-performable angle range Ra2 can be set in three dimensions.

Here, it is assumed that, at the two reference points Q32 and Q33 calculated at the position where the tangent of the measurement target curve C21 is discontinuous, the amount of change in the normal directions between a normal direction V32 and a normal direction V33, which are the normal directions of the measurement object curved surface at the respective reference points, exceeds a predetermined angle range. That is, the normal directions of the reference point Q32 and the reference point Q33, which are two reference points adjacent to each other, change beyond the predetermined angle range.

FIG. 25 is a first diagram illustrating how the measurement path generating device calculates measurement positions and measurement directions of the measurement sensor in the second embodiment. FIG. 25 illustrates a state in which the measurement path generating unit 105 calculates, for the reference point Q31 to the reference point Q34, the measurement positions of the measurement sensor 21 as a measurement position P31 to a measurement position P34, respectively, and the measurement directions of the measurement sensor 21 as a measurement direction V31 to a measurement direction V34, respectively, such that the measurement positions are each at the center of the measurement-performable distance range and that the measurement directions each face the normal direction of the corresponding reference point.

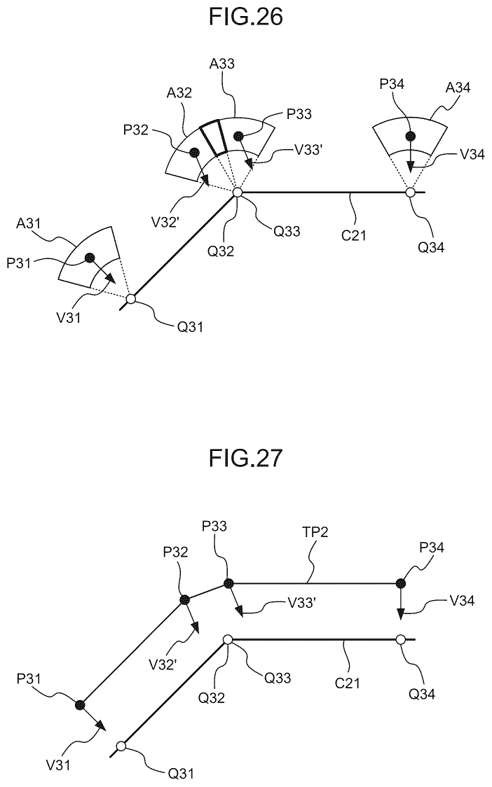

FIG. 26 is a second diagram illustrating how the measurement path generating device calculates the measurement positions and measurement directions of the measurement sensor in the second embodiment. FIG. 26 illustrates a state in which the measurement path generating unit 105 calculates the measurement positions and the measurement directions of the measurement sensor 21 for measuring the reference point at which the amount of change in the normal direction of the measurement object curved surface exceeds the predetermined angle range.

The measurement path generating unit 105 obtains, for a measurement-performable area A32 and a measurement-performable area A33 corresponding to the reference point Q32 and the reference point Q33, a common angle range between the measurement-performable angle ranges of the measurement-performable area A32 and the measurement-performable area A33, the reference points Q32 and Q33 being the reference points where the amount of change in the normal directions of the measurement object curved surface exceeds the predetermined angle range. Then, the measurement path generating unit 105 newly calculates measurement directions within the common angle range. FIG. 26 illustrates a state in which the measurement direction corresponding to the measurement position P32 is adjusted to a measurement direction V32′, and the measurement direction corresponding to the measurement position P33 is adjusted to a measurement direction V33′. In FIGS. 25 and 26, the common angle range between the measurement-performable angle ranges of the measurement-performable area A32 and the measurement-performable area A33 is indicated by a middle thick line.

FIG. 27 is a diagram illustrating how the measurement path generating device generates a measurement path in the second embodiment. FIG. 27 illustrates how a measurement path TP2 is generated in which the measurement position P31 to the measurement position P34 are sequentially connected, and the measurement direction V31, the measurement direction V32′, the measurement direction V33′, and the measurement direction V34 are set as the measurement directions at the corresponding measurement positions, respectively.

An example of the operation of the measurement path generating device 10 in the second embodiment has been described.

In the second embodiment, the measurement path generating unit 105 of the measurement path generating device 10 generates the measurement path with which measurement is performed in the plurality of measurement directions in the case where the normal directions change beyond the predetermined angle range. Thus, the use of the measurement path to perform on-machine measurement of the measurement object 30 by the machine tool 20 has an effect that, when a corner of the measurement object 30 is measured, the measurement path for intensively measuring the corner can be avoided, and the time required for measuring the measurement object 30 can be reduced.

Moreover, with the measurement path, there is an effect that the corner can be measured with high accuracy by avoiding the measurement path for intensively measuring the corner. That is, when measuring the corner that is the boundary between two measurement object curved surfaces, the measurement path generating unit 105 does not generate the measurement path for intensively measuring the corner. Thus, with the use of the measurement path generated by the measurement path generating unit 105, the measurement object curved surface being measured is not frequently switched, which makes it easy to check a measurement result of the corner after the measurement.

Furthermore, the measurement path can avoid intensive output of a large amount of measurement results obtained by measuring the corner, thereby having an effect of reducing the effort of an operator for checking the measurement results after the measurement.

### Third Embodiment

A third embodiment will describe another function of the measurement path generating device 10 according to the first embodiment. In the third embodiment as well, the measurement path generating device 10 basically operates according to the flowchart illustrated in FIG. 4 described above. Hereinafter, the operations of the measurement path generating device 10 that are different from those of the first embodiment will be described. The other operations of the measurement path generating device 10 are similar to those of the first embodiment, and thus will not be described.

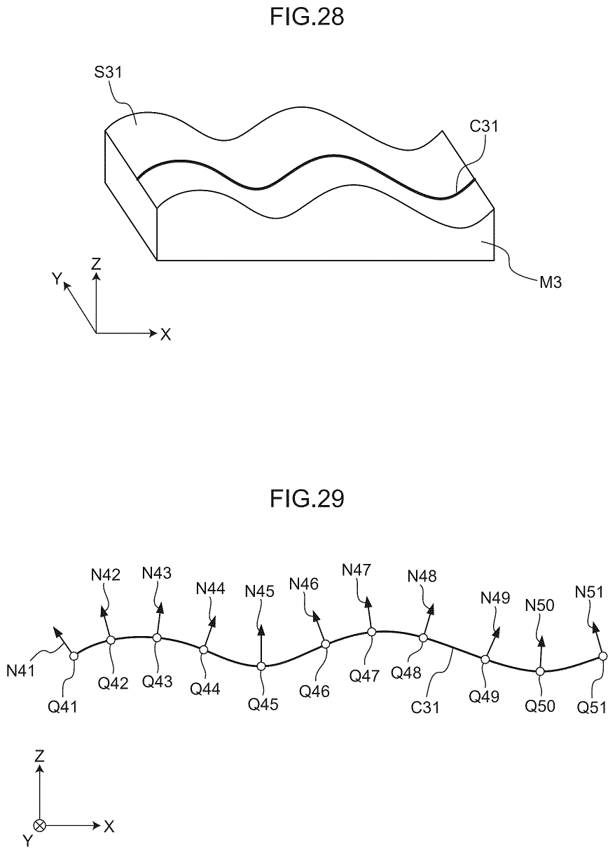

FIG. 28 is a perspective view illustrating a state in which a measurement target curve is generated on a measurement object curved surface of a shape model used by the measurement path generating device in the third embodiment. FIG. 28 illustrates a state in which a measurement target curve C31 is generated on a measurement object curved surface S31 generated on a shape model M3.

FIG. 29 is a diagram illustrating how reference points and normal directions of the measurement object curved surface at the reference points are calculated on the measurement target curve of the shape model used by the measurement path generating device in the third embodiment. FIG. 29 illustrates how reference points Q41 to Q51 are calculated on the measurement target curve C31, and how normal directions N41 to 51 on the measurement object curved surface are calculated at the corresponding reference points.

In the third embodiment, in step S140, the measurement path generating unit 105 generates a measurement path that satisfies the measurement-performable condition and that minimizes the amount of movement of each drive axis of the machine tool 20. Minimizing the amount of movement of each drive axis of the machine tool 20 is minimizing the amount of movement of the drive axis from the last position to the next position in continuous or intermittent movement of the drive axis at the time of measuring the measurement object 30 by moving the measurement sensor 21 attached to the drive axis of the machine tool 20 along the measurement path.

The measurement path generating unit 105 first determines the measurement-performable areas as in the case of the first embodiment. Subsequently, the measurement path generating unit 105 calculates, as in the case of the first embodiment, the measurement position and the measurement direction of the measurement sensor 21 for measuring each reference point. Conveniently, in the measurement-performable area determined for each reference point, the measurement position need only be determined to be the center of the measurement-performable distance range and be the measurement direction facing the normal direction of the reference point.

Here, in order to minimize the amount of movement of each drive axis of the machine tool 20, it is only required to determine a combination of the measurement position and the measurement direction with which changes in a linear axis and a rotary axis of the machine tool 20 are minimized within the measurement-performable area for each reference point. Specifically, the combination of the measurement position and the measurement direction is determined such that, when the measurement position of the measurement sensor 21 is moved along a certain plane, a change in the measurement direction of the measurement sensor 21 is minimized. That is, in the third embodiment, in step S140, the measurement path generating unit 105 generates the measurement path that minimizes the changes in the linear axis and the rotary axis to which the measurement sensor 21 is attached in the machine tool 20 and which move the measurement sensor 21.

For example, the change in the measurement direction of the measurement sensor 21 can be minimized by successively obtaining a common portion between the measurement-performable angle ranges and repeatedly adopting a common measurement direction as long as the common measurement direction is obtained. Alternatively, the measurement position and the measurement direction of the measurement sensor 21 may be changed little by little to enumerate and store all the measurement positions and measurement directions that are possible in the measurement-performable areas, and combinations of the measurement positions and the measurement directions of the measurement sensor 21 for all the measurement-performable areas may be evaluated to determine the combination of the measurement position and the measurement direction that minimizes the changes in the linear axis and the rotary axis of the machine tool 20.

Then, the measurement path generating unit 105 generates the measurement path by sequentially connecting the measurement positions calculated and setting the measurement directions calculated at the corresponding measurement positions as the measurement directions of the measurement sensor 21.

Hereinafter, a description will be given of a specific example of the case where the measurement path generating device calculates the measurement positions and the measurement directions of the measurement sensor in the third embodiment.

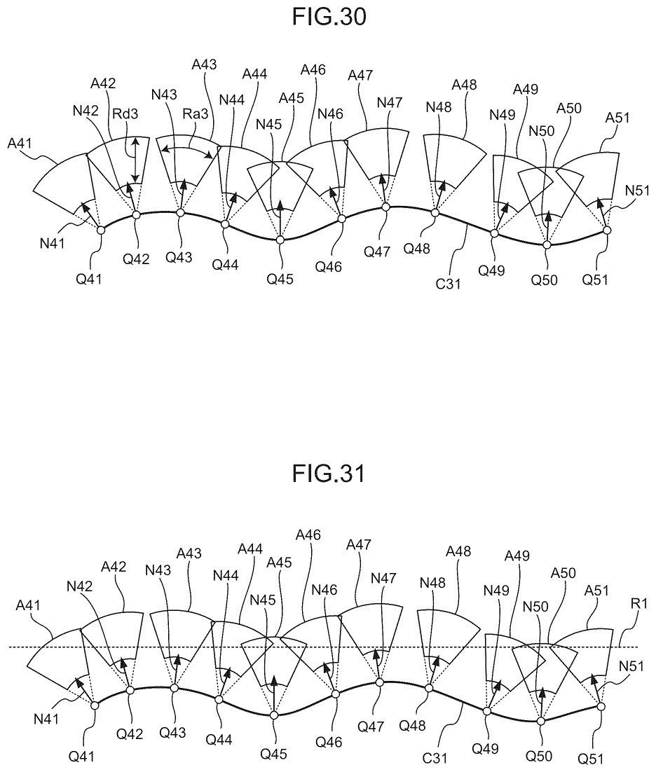

FIG. 30 is a diagram illustrating an example of the measurement-performable areas determined on the basis of the measurement-performable distance range and the measurement-performable angle range in the shape model used by the measurement path generating device in the third embodiment. In FIG. 30, a measurement-performable distance range Rd3 and a measurement-performable angle range Ra3 are set as predetermined values, and on the basis of the measurement-performable distance range Rd3 and the measurement-performable angle range Ra3, a measurement-performable area A41 to a measurement-performable area A51 are illustrated as areas where the measurement sensor 21 can perform measurement for measuring the reference point Q41 to the reference point Q51, respectively.

FIG. 31 is a diagram illustrating a state in which a plane R1, which is a plane along which the measurement positions can be moved in all the measurement-performable areas, is determined in the shape model used by the measurement path generating device in the third embodiment.

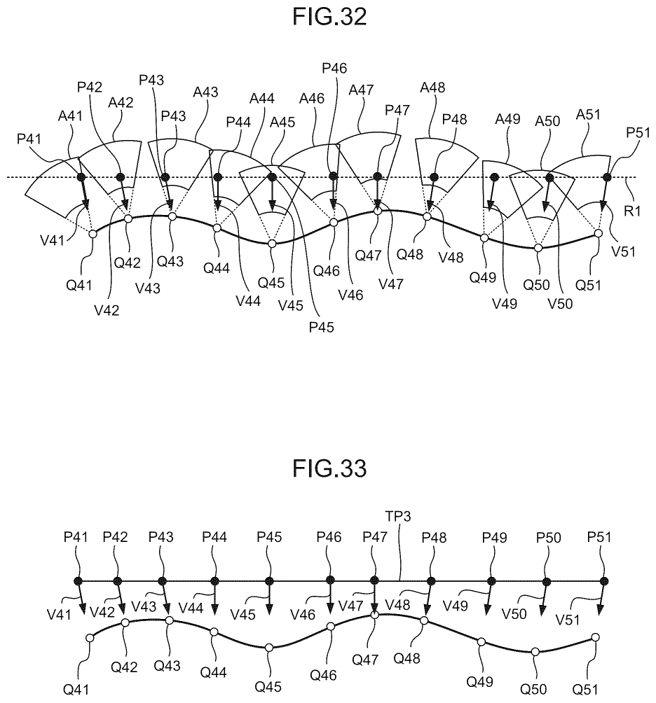

FIG. 32 is a diagram illustrating how the measurement path generating device calculates the measurement positions and the measurement directions of the measurement sensor in the third embodiment. FIG. 32 illustrates a state in which, for the reference points Q41 to Q51, the measurement path generating unit 105 generates the measurement positions of the measurement sensor 21 as measurement positions P41 to P51 to be on the plane R1 determined, respectively, and determines the measurement directions of the measurement sensor 21 as a measurement direction V41 to a measurement direction V51, respectively, such that the amount of change in the measurement direction of the measurement sensor 21 is minimized.

Here, as a method of obtaining the measurement direction V41 to the measurement direction V51, in the measurement-performable area A41 to the measurement-performable area A51 corresponding to the reference point Q41 to the reference point Q51, possible common measurement directions among each of the measurement-performable area A41 to the measurement-performable area A43, the measurement-performable area A44 to the measurement-performable area A47, and the measurement-performable area A48 to the measurement-performable area A51 may be obtained, and a combination of the possible measurement directions with the least amount of change may be determined.

FIG. 33 is a diagram illustrating how the measurement path generating device generates the measurement path in the third embodiment. FIG. 33 illustrates how a measurement path TP3 is generated in which the measurement position P41 to the measurement position P51 are sequentially connected, and the measurement direction V41 to the measurement direction V51 are set as the measurement directions at the corresponding measurement positions, respectively.

An example of the operation of the measurement path generating device 10 in the third embodiment has been described.

In the third embodiment, the measurement path generating unit 105 of the measurement path generating device 10 generates the measurement path that minimizes the amount of movement of each drive axis of the machine tool 20. That is, the measurement path generating unit 105 can reduce the time required for measurement by selecting the measurement path with the minimum amount of movement of each drive axis of the machine tool 20 among a plurality of the possible measurement paths. Thus, the use of the measurement path to perform on-machine measurement of the measurement object 30 by the machine tool 20 has an effect that the time required for measuring the measurement object 30 can be reduced.

Next, a hardware configuration of each of control units 80 according to the first to third embodiments will be described. The control units 80 according to the first to third embodiments correspond to the path processing unit 12 and the control unit 15 in the measurement path generating device 10. The functions of each of the control units 80 according to the first to third embodiments are implemented by processing circuitry. The processing circuitry may be dedicated hardware or a processing device that executes a program stored in a storage device.

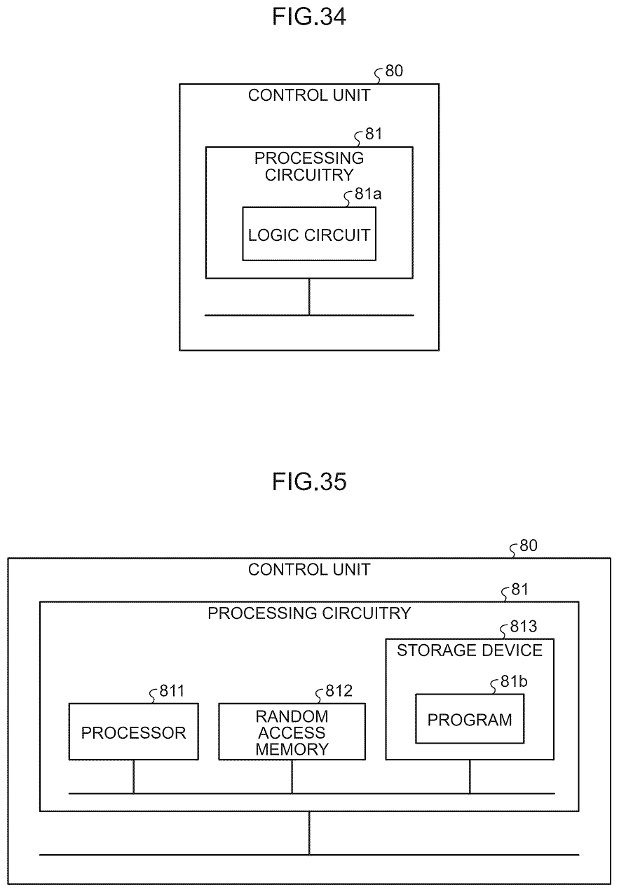

In a case where the processing circuitry is the dedicated hardware, the processing circuitry corresponds to a single circuit, a composite circuit, a programmed processor, a parallel programmed processor, an application specific integrated circuit, a field programmable gate array, or a combination thereof. FIG. 34 is a diagram illustrating a configuration in which the functions of each of the control units according to the first to third embodiments are implemented by the hardware. Processing circuitry 81 incorporates a logic circuit 81a that implements the functions of the control unit 80.

In a case where the processing circuitry 81 is the processing device, the functions of the control unit 80 are implemented by software, firmware, or a combination of software and firmware.

FIG. 35 is a diagram illustrating a configuration in which the functions of each of the control units according to the first to third embodiments are implemented by the software. The processing circuitry 81 includes a processor 811 that executes a program 81b, a random access memory 812 used as a work area by the processor 811, and a storage device 813 that stores the program 81b. The processor 811 expands the program 81b stored in the storage device 813 in the random access memory 812 and executes the program 81b, whereby the functions of the control unit 80 are implemented. The software or firmware is described in a program language and stored in the storage device 813. The processor 811 includes a central processing unit, but is not limited thereto. The storage device 813 can use a semiconductor memory such as a random access memory (RAM), a read only memory (ROM), a flash memory, an erasable programmable read only memory (EPROM), or an electrically erasable programmable read only memory (EEPROM (registered trademark) ). The semiconductor memory may be a non-volatile memory or a volatile memory. Besides the semiconductor memory, the storage device 813 can use a magnetic disk, a flexible disk, an optical disc, a compact disc, a mini disc, or a digital versatile disc (DVD). Note that the processor 811 may output data such as a calculation result to the storage device 813 and store the data therein, or may store the data in an auxiliary storage device (not illustrated) via the random access memory 812. When the processor 811, the random access memory 812, and the storage device 813 are integrated on one chip, the functions of the control unit 80 can be implemented by a microcomputer.

The processing circuitry 81 reads and executes the program 81b stored in the storage device 813, thereby implementing the functions of the control unit 80. It can also be said that the program 81b causes a computer to execute procedures and methods for implementing the functions of the control unit 80.

In the processing circuitry 81 for implementing each of the path processing unit 12 and the control unit 15 in the measurement path generating device 10, the program 81b includes the measurement path generating program for generating the measurement path.

Note that the processing circuitry 81 may implement some of the functions of the control unit 80 by the dedicated hardware and implement some of the functions of the control unit 80 by the software or firmware.

As described above, the processing circuitry 81 can implement the aforementioned functions by the hardware, software, firmware, or a combination thereof.

The configurations illustrated in the above embodiments each merely illustrate an example so that another known technique can be combined, the embodiments can be combined together, or the configurations can be partially omitted and/or modified without departing from the scope of the present disclosure.

### REFERENCE SIGNS LIST

1 measurement system; 10 measurement path generating device; 11 operation unit; 12 path processing unit; 13 storage unit; 14 communication unit; 15 control unit; 20 machine tool; 21 measurement sensor; 22 numerical controller; 23 servo control unit; 30 measurement object; 101 shape model storage unit; 102 measurement target curve generating unit; 103 measurement object curved surface designating unit; 104 reference point calculating unit; 105 measurement path generating unit; 106 measurement environment information storage unit; 107 display unit; 108 interference determination unit; 109 measurement program output unit; A1 to A25, A31 to A34, A41 to A51 measurement-performable area; C11, C12, C13, C21, C31 measurement target curve; M1, M2, M3 shape model; N1 to N25, N31 to N34, N41 to N51 normal direction; P1 to P25, P31 to P, P41 to P51, P2′, P3′ measurement position; PL1, PL2, PL3 plane; Q1 to Q25, Q31 to Q34, Q41 to Q51 reference point; R1 plane; Ra1, Ra2, Ra3 measurement-performable angle range; Rd1, Rd2, Rd3 measurement-performable distance range; S1 to S15, S21, S22, S31 curved surface; TP1, TP2, TP3 measurement path; V1 to V25, V31 to V34, V41 to V51, V2′, V3′ measurement direction.

1. A measurement path generator that generates a measurement path for measuring a measurement object by a measurement sensor on a machine tool, the measurement path being a movement path that is relative between the measurement sensor and the measurement object, the measurement path generator comprising:
a shape model storage circuitry that stores a shape model of the measurement object;
a measurement target curve generating circuitry to generate a measurement target curve that is a curve on a measurement object curved surface of the shape model;
a reference point calculating circuitry to calculate a reference point that is a point on the measurement target curve and a normal direction of the measurement object curved surface at the reference point; and
a measurement path generating circuitry to generate the measurement path, which is the movement path for performing measurement on the measurement target curve, on the basis of the reference point, the normal direction, a measurement-performable distance range that is a distance range in which measurement can be performed between the measurement sensor and the measurement target curve, and a measurement-performable angle range that is a relative angle range in which measurement can be performed between a measurement direction of the measurement sensor and the normal direction of the measurement object curved surface.

2. The measurement path generator according to claim 1, wherein
the measurement target curve generating circuitry generates a plane and generates an intersection line between the plane and the measurement object curved surface as the measurement target curve.

3. The measurement path generator according to claim 1, wherein
the measurement path generating circuitry determines a measurement-unperformable section in which the measurement path cannot be generated on the measurement target curve, and generates a measurement path including a detour measurement path that bypasses the measurement-unperformable section.

4. The measurement path generator according to claim 1, wherein
in a case where the normal direction of two of the reference points adjacent to each other changes beyond a predetermined angle range, the measurement path generating circuitry divides a portion including the two of the reference points of the measurement path into a plurality of sections, sets a different measurement direction for each of the sections divided, and generates the measurement path for performing measurement.

5. The measurement path generator according to claim 1, wherein
the measurement path generating circuitry generates a measurement path that minimizes changes in a linear axis and a rotary axis to which the measurement sensor is attached in the machine tool and which move the measurement sensor.

6. The measurement path generator according to claim 1, comprising
a display, wherein
the display displays the measurement target curve and the measurement path for performing measurement on the measurement target curve in association with each other.

7. The measurement path generator according to claim 1, comprising
a display, wherein
in a case where the measurement path generating circuitry determines a measurement-unperformable section in which the measurement path cannot be generated on the measurement target curve, the measurement-unperformable section is displayed on the display circuitry distinctively from a section in which the measurement path is generated.

8. The measurement path generator according to claim 1, comprising
a measurement program output circuitry to output a measurement program that describes a command for relatively moving the measurement sensor and the measurement object on the basis of a configuration of a drive axis, to which the measurement sensor is attached in the machine tool and which moves the measurement sensor, and the measurement path.

9. The measurement path generator according to claim 8, wherein
in a case where the measurement path generating circuitry determines a measurement-unperformable section in which the measurement path cannot be generated on the measurement target curve, the measurement program output circuitry outputs a measurement program in which a command corresponding to the measurement path included in the measurement-unperformable section is described distinctively from a command corresponding to a section in which the measurement path is generated.

10. The measurement path generator according to claim 1, wherein
the measurement sensor is an optical distance sensor.

11. The measurement path generator according to claim 10, wherein
the optical distance sensor measures a distance to the measurement object by frequency scanning interferometry.

12. The measurement path generator according to claim 1, comprising
a measurement environment information storage circuitry that stores measurement environment information that is information related to a measurement environment when the measurement sensor measures the measurement object, wherein
the measurement path generating circuitry determines the measurement-performable distance range and the measurement-performable angle range on the basis of the measurement environment information.

13. The measurement path generator according to claim 12, wherein
the measurement environment information includes at least one of a type of the measurement sensor, a measurement method of the measurement sensor, a wavelength of output light of the measurement sensor, a focal length of the measurement sensor, a measurement cycle of the measurement sensor, material of the measurement object, or surface roughness of the measurement object.

14. The measurement path generator according to claim 13, wherein
the measurement path generating circuitry determines, according to the measurement cycle of the measurement sensor among the measurement environment information, a relative speed of movement between the measurement sensor and the measurement object such that an interval between positions on the measurement target curve where measurement is performed is constant for each measurement cycle.

15. A measurement path generating method that generates a measurement path for measuring a measurement object by a measurement sensor on a machine tool, the measurement path being a movement path that is relative between the measurement sensor and the measurement object, the measurement path generating method comprising:
storing a shape model of the measurement object;
generating a measurement target curve that is a curve on a measurement object curved surface of the shape model;
obtaining a reference point that is a point on the measurement target curve and a normal direction of the measurement object curved surface at the reference point; and
generating the measurement path, which is the movement path for performing measurement on the measurement target curve, on the basis of the reference point, the normal direction, a measurement-performable distance range that is a distance range in which measurement can be performed between the measurement sensor and the measurement target curve, and a measurement-performable angle range that is a relative angle range in which measurement can be performed between a measurement direction of the measurement sensor and the normal direction of the measurement object curved surface.

16. A measurement system comprising:
a machine tool;
a measurement sensor to measure a measurement object disposed in a machine tool;
a shape model storage circuitry that stores a shape model of the measurement object;
a measurement target curve generating circuitry to generate a measurement target curve that is a curve on a measurement object curved surface of the shape model;
a reference point calculating circuitry to calculate a reference point that is a point on the measurement target curve and a normal direction of the measurement object curved surface at the reference point; and
a measurement path generating circuitry to generate a measurement path, which is a movement path for performing measurement on the measurement target curve and is a movement path that is relative between the measurement sensor and the measurement object, on the basis of the reference point, the normal direction, a measurement-performable distance range that is a distance range in which measurement can be performed between the measurement sensor and the measurement target curve, and a measurement-performable angle range that is a relative angle range in which measurement can be performed between a measurement direction of the measurement sensor and the normal direction of the measurement object curved surface.
